(19) United States
(12) Patent Application Publication
(10) Pub. No.: US 2026/0289099 A1
(43) Pub. Date: Sep. 24, 2026

(54) SYSTEM

(71) Applicant: SoftBank Group Corp., Tokyo (JP)

(72) Inventor: Naoko NAKANISHI, Tokyo (JP)

(73) Assignee: SoftBank Group Corp., Tokyo (JP)

(21) Appl. No.: 19/567,042

(22) Filed: Mar. 14, 2026

(30) Foreign Application Priority Data
Mar. 19, 2025 (JP) 2025-045230

(51) Int. Cl. G06F 40/183; G06F 40/103; G06F 40/169; G06T 11/26

(52) U.S. Cl. CPC G06F 40/183; G06F 40/103; G06F 40/169; G06T 11/26

(57) ABSTRACT

A system includes a processor that is configured to acquire and integrate municipal open data and private-sector data, calculate evaluation criteria using the integrated data, and automatically generate report documents based on a prompt by using a generative AI model.

### CROSS-REFERENCE TO RELATED APPLICATION

This application is based on and claims priority under 35 USC 119 from Japanese Patent Application No. 2025-045230 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for preparing policy reports, grant applications, and administrative documents require municipal staff to manually collect municipal open data and private-sector data, integrate heterogeneous datasets, and compute complex evaluation criteria. Such manual processes are time-consuming, prone to human error, and difficult to scale when the volume of data and the number of required indicators increase. Furthermore, existing document generation tools generally rely on static templates and lack the capability to dynamically use generative AI models based on prompts, which results in limited flexibility and poor adaptability of the report content. In addition, conventional systems do not adequately support region-specific analysis based on combinations of particular municipal datasets and particular private-sector datasets, and they fail to personalize the content or tone of generated documents according to a user's emotional state. Accordingly, there is a need for a system that can automatically acquire and integrate municipal open data and private-sector data, calculate evaluation criteria from the integrated data, and generate report documents and supplementary materials using a generative AI model in a manner that supports region-specific analysis and allows adjustment of output information in accordance with a user's emotion.

### SUMMARY

To solve the above-described problems, a system according to one aspect of the present invention includes a processor, wherein the processor is configured to acquire and integrate municipal open data and private-sector data, calculate evaluation criteria using the integrated data, and automatically generate report documents based on a prompt by using a generative AI model. The processor is further configured to identify a combination of data of a specific municipality and specific private-sector data so as to enable region-specific analysis, thereby producing evaluation criteria and analytical results that reflect local characteristics. Moreover, the processor is configured to create report documents and supplementary materials based on a specific format, and to adjust an output result by using a prompt to instruct the generative AI model to perform an adjustment so as to adjust information in accordance with a user's emotion. Through these configurations, the system automates data acquisition, integration, and evaluation, enables flexible and context-aware document generation through generative AI, supports detailed region-specific analysis, and provides personalized document content that is responsive to a user's emotional state.

The term “municipal open data” refers to publicly available data sets published or provided by a local government or municipality, including, for example, demographic data, budget data, infrastructure data, and other administrative statistics.

The term “private-sector data” refers to data collected, held, or provided by non-governmental entities such as corporations, research organizations, or data providers, including, for example, consumer behavior data, transaction data, and market activity data.

The term “integrate” refers to combining, correlating, or otherwise associating multiple data sets, such as municipal open data and private-sector data, into a unified or interoperable data structure that can be used for analysis or calculation.

The term “evaluation criteria” refers to quantitative or qualitative indicators, metrics, key performance indicators (KPIs), thresholds, or other measures that are calculated from integrated data and used to evaluate policies, projects, grants, or other administrative objectives.

The term “generative AI model” refers to a machine learning model, such as a neural network, that is capable of generating textual or other content in response to an input, including but not limited to large language models or similar generative models.

The term “prompt” refers to an input instruction, query, or context information provided to a generative AI model, which guides or constrains the content, style, or structure of the output generated by the generative AI model.

The term “report documents” refers to electronic or printed documents generated by the system, including, for example, policy reports, analysis reports, grant application documents, administrative summaries, or similar materials.

The term “supplementary materials” refers to documents or content that accompany or augment report documents, including, for example, annexes, appendices, explanatory notes, charts, tables, or graphical materials.

The term “region-specific analysis” refers to analysis that is focused on a particular geographic area, such as a specific municipality or region, and that uses combinations of data corresponding to that area to derive localized evaluation criteria or insights.

The term “specific municipality” refers to a particular local government entity or administrative division identified by an identifier, name, or code within the system.

The term “specific private-sector data” refers to one or more particular private-sector data sets or sources that are selected or identified in association with a specific municipality for use in region-specific analysis.

The term “specific format” refers to a predetermined or configurable document structure or layout, including defined sections, headings, fields, and data placement rules, which the system uses when creating report documents and supplementary materials.

The term “user's emotion” refers to an emotional state or preference of a user, such as satisfaction, concern, urgency, optimism, or caution, which is inferred or specified and used to influence the tone, emphasis, or level of detail of generated content.

The term “adjust an output result” refers to modifying or controlling one or more aspects of the content produced by the generative AI model, such as style, tone, emphasis, or level of detail, based on prompts or other instructions.

The term “processor” refers to one or more hardware processors, such as CPUs, GPUs, or dedicated processing units, and may include a collection of processing elements working together to execute instructions and perform the functions described in the claims.

The term “system” refers to a combination of hardware and software components, including at least the processor and associated memory, storage, communication interfaces, and execution environment configured to perform the functions recited in the claims.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

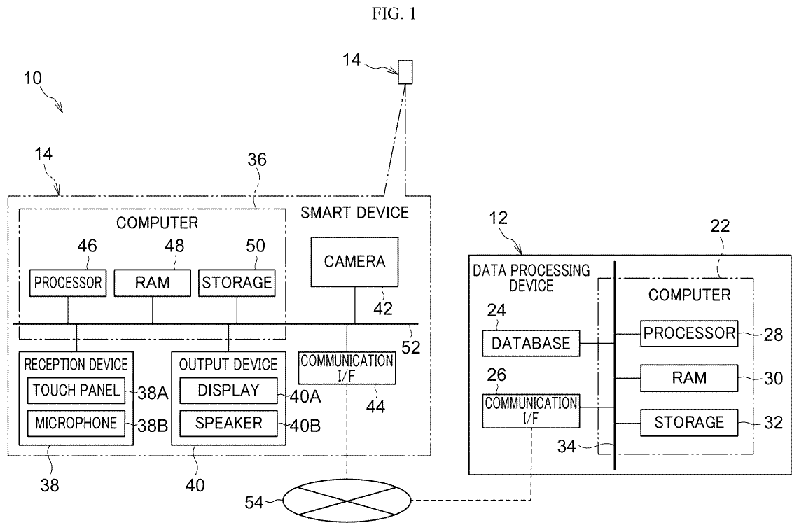

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

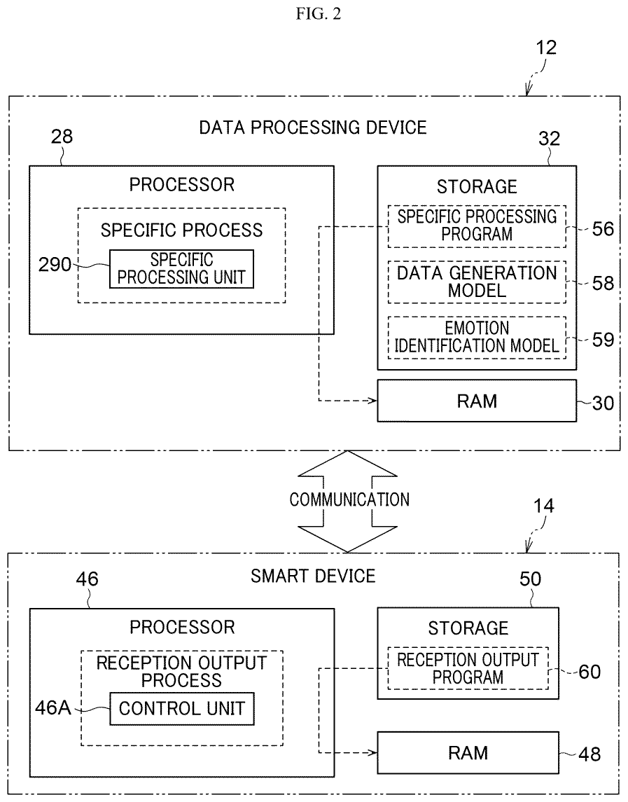

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems that generate planning and reporting documents for public infrastructure and related social capital development typically treat public data and private data as separate, loosely coupled information sources. In many cases, public datasets, such as demographic and budget records, are stored in heterogeneous formats with inconsistent identifiers, while private datasets, such as market trends or behavioral indicators, are separately maintained in different formats. As a result, existing systems require substantial manual preprocessing, ad hoc scripting, or spreadsheet operations to normalize, align, and integrate such datasets before any meaningful analysis can be performed. This fragmented data handling impairs the efficiency, reliability, and repeatability of data-driven decision support.

Furthermore, conventional systems that make use of generative AI models generally pass only a free-form prompt sentence authored by a user, without systematically binding that prompt to a rigorously defined, machine-computed set of indicators and evaluation criteria. In such systems, the generative AI model operates on loosely specified context, often lacking explicit, structured representations of change rates, ratios, or per-capita resource allocations derived from integrated multi-source data. This leads to outputs that are difficult to reproduce, difficult to audit, and potentially misaligned with actual underlying quantitative conditions.

Existing document generation tools for multi-year applications, reports, and supplementary materials also tend to rely on static templates and manual editing. While some tools can auto-fill fields, they generally do not control end-to-end data flow from normalized database integration, through indicator computation, to structured, model-guided narrative generation. Tabular and graphical elements are often generated separately from text, requiring manual assembly and risking inconsistencies between narrative explanations and quantitative representations.

In addition, current architectures do not adequately exploit a unified processor configuration that both (i) enforces a normalized, constraint-aware information structure for integrated data and derived indicators, and (ii) programmatically constructs structured inputs to a generative AI model, incorporating user prompt sentences, computed evaluation criteria, and analysis results in a coherent manner. Without such a configuration, the system cannot reliably provide geographically specific, multi-period resource allocation plans and report documentation that are consistent across textual, tabular, and graphical modalities.

Accordingly, there is a need for an improved computer-implemented system that enhances core computer functionality by: (1) automatically integrating heterogeneous structured information from public and non-public entities into a normalized, constraint-managed information structure; (2) programmatically computing indicator information and evaluation criteria that capture change rates, ratios, and per-unit resource allocations; (3) generating structured input information sets that bind these computed values with user-supplied prompt sentences for a generative AI model; and (4) automatically creating consistent, multi-year report documentation in which model-generated draft text is coherently combined with automatically generated tabular information and graphical information. Such a system should reduce manual processing, improve computational consistency and traceability, and provide a technically improved pipeline for data-driven, AI-assisted planning and reporting.

The specific processing by the specific processing unit 290 of the data processing device 12 in Example 1 is realized by the following means.

The present invention provides a server comprising a processor and a storage device, the processor being configured to acquire structured information from public entities and structured information from non-public entities, normalize formats and identifiers of the structured information, and generate an integrated information set by associating the structured information with each other; to set, on the storage device, an information structure including attribute types, constraint conditions, and association relationships, and to record the integrated information set in accordance with the information structure while maintaining consistency of the integrated information set; to obtain the integrated information set and to generate indicator information including change rates of quantitative information, ratios of quantitative information, and resource allocation amounts per unit quantity by performing a calculation, and to set evaluation criteria relating to social capital development based on the indicator information; to generate analysis results including an information summary and a resource allocation plan over a plurality of periods based on the evaluation criteria and the indicator information, and to record the analysis results as structured information; to generate an input information set including a prompt sentence input by a user, the evaluation criteria, and the analysis results, and to configure the input information set as an input to a generative AI model; to transmit, to the generative AI model, the input information set including the prompt sentence, and to obtain, from the generative AI model, response information including draft information of application documents, report documents, and supplementary materials over a plurality of years; and to automatically generate tabular information and graphical information conforming to a predetermined format based on the response information and the indicator information, and automatically create report documentation in which the tabular information and the graphical information are incorporated into the draft information. This enables an improved computer-implemented workflow in which heterogeneous structured data are automatically normalized and integrated under a constraint-managed information structure, quantitative indicators and evaluation criteria are consistently computed and bound into a structured input for a generative AI model, and multi-year application and reporting documents are automatically produced as coherent combinations of model-generated text and system-generated tables and graphics, thereby reducing manual intervention, enhancing processing reliability, and improving the technical efficiency of data-driven planning and reporting operations.

The term “structured information” refers to information represented in a machine-readable format with explicit fields, data types, and value delimiters, such as records in a table, entries in a database, or data in a standardized file format, in a manner that enables deterministic parsing and programmatic processing.

The term “public entity” refers to an organization belonging to a governmental or quasi-governmental body, including national, regional, or local administrative units or public agencies, that provides data related to population, budgets, infrastructure, or similar public matters.

The term “non-public entity” refers to an organization or individual that is not part of a governmental or quasi-governmental body, including private-sector organizations, research institutions, or other non-governmental actors that provide data such as market information, behavioral information, or other privately collected information.

The term “integrated information set” refers to a collection of data obtained by combining multiple items of structured information from different sources, after normalizing their formats and identifiers, so that the resulting data can be jointly processed as a coherent and cross-referenced dataset.

The term “normalize” refers to processing that converts heterogeneous formats, units, identifiers, or naming conventions of data elements into a common, standardized representation that allows consistent storage, comparison, and computation across different data sources.

The term “identifier” refers to a value, code, or label, such as a region code, organization ID, or time index, which uniquely or consistently distinguishes one entity, record, or element from another within or across datasets.

The term “information storage device” refers to any computer-readable medium, such as a magnetic storage device, an optical storage device, a semiconductor memory, or a networked storage system, that is configured to store data, metadata, or program instructions.

The term “information structure” refers to a logical description of how data are organized and related within an information storage device, including definitions of attributes, data types, constraints, and relationships that govern how records are stored, accessed, and maintained.

The term “attribute type” refers to a specification of the permissible kind and format of data values for a given attribute, such as numeric type, character string type, date type, or Boolean type, as used in defining fields within records or database columns.

The term “constraint condition” refers to a rule or restriction applied to data values or relationships among data values, such as uniqueness constraints, non-null constraints, referential integrity constraints, range constraints, or other conditions that preserve data consistency and validity.

The term “association relationship” refers to a defined linkage between two or more data entities, such as a relational key relationship between tables or a mapping between records, which enables cross-referencing and joint processing of related data elements.

The term “indicator information” refers to computed values derived from raw data, such as change rates, ratios, averages, or per-unit metrics, that summarize or quantify underlying phenomena to support evaluation, comparison, or decision-making.

The term “change rate of quantitative information” refers to a value that expresses the degree of increase or decrease of a numerical quantity over a specified interval, such as a growth rate or decline rate, typically computed as a difference or percentage between values at different times.

The term “ratio of quantitative information” refers to a value obtained by dividing one numerical quantity by another numerical quantity, such as a utilization ratio, coverage ratio, or efficiency ratio, in order to express a relative magnitude or proportion.

The term “resource allocation amount per unit quantity” refers to a metric that represents how much of a given resource, such as financial budget, infrastructure capacity, or service volume, is allocated or consumed for each unit of another quantity, such as per person, per area, or per unit of demand.

The term “evaluation criteria” refers to a set of conditions, thresholds, target values, or scoring formulas, derived from indicator information or policy requirements, that are used to assess, compare, or guide decisions about social capital development or resource allocation.

The term “social capital development” refers to planning, construction, maintenance, or improvement of physical or service-related public assets, such as transportation networks, utilities, public facilities, or similar infrastructure, that support societal and economic activities.

The term “analysis results” refers to structured outputs generated by processing the integrated information set and indicator information, including summaries, classifications, forecasts, or other derived data that describe or interpret the underlying information.

The term “resource allocation plan” refers to structured information specifying how resources, such as budgets or capacities, are to be distributed across regions, categories, or time periods, including target amounts, priorities, and scheduling over a plurality of periods.

The term “plurality of periods” refers to two or more distinct time intervals, such as multiple years, quarters, or other time units, for which data are analyzed or for which plans and documents are generated.

The term “prompt sentence” refers to a natural-language instruction or request provided by a user to guide operations of a generative AI model, including specification of desired outputs, constraints, or focus areas.

The term “input information set” refers to a collection of data elements and metadata, including at least a prompt sentence, evaluation criteria, and analysis results, which is organized into a structure suitable for input to a generative AI model.

The term “generative AI model” refers to a machine-implemented model, such as a large-scale neural network model, that generates content including text, tables, or other representations in response to input information, based on learned parameters obtained from training data.

The term “response information” refers to information output by a generative AI model in response to an input information set, including generated text, structured recommendations, or other content that can be further processed by the system.

The term “draft information” refers to automatically generated textual content that forms a preliminary version of documents such as application documents, report documents, or supplementary materials, prior to any optional manual revision.

The term “application document” refers to a document prepared for submission to an approving entity, such as a funding authority or administrative body, that describes requested resources, plans, or justifications over one or more periods.

The term “report document” refers to a document that summarizes outcomes, status, or performance of implemented plans or allocated resources over one or more periods, typically including quantitative and qualitative information.

The term “supplementary materials” refers to additional documents or content, such as detailed tables, charts, appendices, or explanatory notes, that accompany an application document or report document to provide supporting information.

The term “tabular information” refers to information arranged in rows and columns, such as tables generated from numerical or categorical data, which can be embedded in documents or displayed as structured grids.

The term “graphical information” refers to visual representations of data, including graphs, charts, or diagrams, such as line graphs, bar charts, or pie charts, that are generated from underlying numerical or categorical data.

The term “report documentation” refers to a combined output document or set of documents, including narrative text, tabular information, and graphical information, that presents plans, analyses, or results in a coherent and publishable form.

The term “geographic area” refers to a spatially defined region, such as a municipality, district, zone, or other administrative or analytical unit, to which data, indicators, or plans can be associated.

The term “format definition information” refers to data describing layout rules, section structures, field positions, and styling or formatting parameters for documents, which guide how draft information, tabular information, and graphical information are arranged in a final document.

The term “document structure” refers to an arrangement of document components, including sections, paragraphs, tables, and figures, in accordance with format definition information, so that the resulting document satisfies a predetermined organization and presentation format.

The term “attribute information of the user” refers to information about a user's characteristics, such as role, expertise level, or organizational affiliation, which can be used to tailor the content or style of generated outputs.

The term “reaction information of the user” refers to information representing a user's feedback or interaction results, such as selection actions, satisfaction signals, correction inputs, or preference indications, which can inform adjustment of further generated outputs.

The term “adjustment condition” refers to one or more parameters or rules, derived from attribute information or reaction information of the user, that are applied to modify a prompt sentence, an input information set, or post-processing of response information.

The term “processor” refers to one or more hardware-based processing units, such as central processing units, graphics processing units, or specialized accelerators, configured to execute program instructions that implement the functions described in the system.

In one or more embodiments, a server, a terminal, and a user cooperate to implement the claimed system using concrete hardware and software components, and to execute specific data structures and algorithms that improve the operation of computer systems for integrated data management and AI-assisted document generation.

### A. Overall Hardware and Software Configuration

The server includes at least one processor, a main memory, a non-volatile storage device, and a network interface. The processor can be a general-purpose central processing unit, a graphics processing unit, or a combination thereof. The storage device can be implemented by a magnetic disk, a semiconductor storage device, or a network-attached storage system.

The server executes an operating system such as a general-purpose server operating system and application programs including a web application framework, a database management system, and analysis libraries.

The server uses a relational database management system such as a general SQL-based database engine (for example, a MySQL-compatible engine or a PostgreSQL-compatible engine). The server uses a high-level programming language such as Python and associated libraries including a data-frame processing library (for example, a Pandas-compatible library), a database driver (for example, a driver compatible with psycopg2 or a MySQL connector), and a document generation library (for example, a library analogous to python-docx, openpyxl, or a PDF generation library).

The terminal includes a processor, a memory, a storage device, a display, and an input device.

The terminal executes a client operating system and runs a web browser (for example, a browser such as Google Chrome or Microsoft Edge), or a native application. The terminal communicates with the server through a network using a protocol such as HTTPS. The terminal may also execute local analysis programs using Python and a Pandas-compatible library, and may include visualization libraries such as a Matplotlib-compatible or Plotly-compatible library.

The server accesses a generative AI model through a dedicated AI inference environment. In one embodiment, the generative AI model is deployed on separate AI hardware including graphics processors or specialized accelerators. In another embodiment, the generative AI model is provided as an external network service accessible via an API. The server uses an API client library analogous to an OpenAI client library to send input data and receive responses.

### B. Data Structures and Information Integration

The server stores public-entity structured information and non-public-entity structured information in the relational database. The server uses database schemas including tables, columns, data types, primary keys, foreign keys, and indexes. Example tables include a population table, a budget allocation table, a budget execution table, and a private-market indicator table. Each table includes fields such as region identifier, time period (for example, a year or quarter), numerical values, and categorical attributes.

The server defines an integrated information set as a separate table or a view that joins the public-entity tables and non-public-entity tables. The server normalizes identifiers by mapping various region labels, administrative codes, and textual names to a standardized region identifier format, for example, a canonical numeric or alphanumeric code. The server normalizes units, such as converting financial values into a single currency unit and ensuring uniform scaling (for example, all monetary values in base units instead of thousands). The server converts date representations into a standard calendar format and stores them as typed date fields.

The server maintains constraint conditions, such as non-null constraints on critical keys (region, time period), referential integrity constraints between detail tables and master tables, and check constraints on valid value ranges. The server enforces these constraints when writing and updating the integrated information set. This constraint management reduces data inconsistency and improves the reliability of subsequent computations, thereby improving data integrity beyond what is possible with manual spreadsheet integration.

The server creates auxiliary index structures on frequently used columns, such as region identifier, time period, and indicator-type, to accelerate query performance. By organizing the integrated information set with multiple indexes and normalized schemas, the server reduces query time for large multi-year and multi-region datasets, thereby improving processing speed and scalability.

### C. Indicator Computation and Evaluation Criteria

The server obtains data from the integrated information set and computes indicator information using a combination of SQL queries and in-memory data-frame processing. For example, the server uses SQL window functions or equivalent data-frame operations to compute change rates of population, budget execution ratios, and per-capita expenditures.

The server calculates a change rate of quantitative information by grouping records by region and ordering by time period, then computing the difference and dividing by a previous value. For example, a population growth rate is calculated as (population at time t-population at time t-1)/population at time t-1. The server computes a ratio of quantitative information, such as budget execution efficiency, as executed budget/allocated budget. The server computes a resource allocation amount per unit quantity, such as budget per person, as executed budget/population.

The server stores these indicator values in indicator tables that include dimensions of region, time period, indicator type, and indicator value. The server defines evaluation criteria using thresholds, target values, and score functions stored as records. For example, the server records that a budget efficiency target is 0.9 or greater, or that a per-capita infrastructure investment target is a specified numeric value.

The server applies non-conventional rule-based processing to evaluate the indicators. For example, the server combines multiple indicators using weighting coefficients not limited to equal weighting; the server stores these coefficients in configuration tables and computes composite scores via matrix-style multiplications or weighted sums in an analysis module. This composite evaluation allows the server to produce ranking lists and priority groups of regions in a consistent automated manner, improving the reproducibility and fairness of the evaluation process compared to ad hoc human judgment.

### D. Construction of Structured Input for the Generative AI Model

The terminal displays indicator values and evaluation criteria to the user and allows the user to input a prompt sentence. For example, the user uses the terminal to enter:

“Using the provided indicators for population growth, budget efficiency, and investment per capita, please generate a three-year infrastructure investment plan that maximizes social capital development while respecting the specified annual budget limits for each region.” or

“Please generate proposals to optimize next year's budget allocation for road, water, and public transportation infrastructure, based on the provided population growth rates and budget efficiency indicators.”

The terminal sends the user's prompt sentence to the server together with contextual metadata such as the selected regions and time periods. The server retrieves relevant indicator values and evaluation criteria from the database and assembles an input information set. This input information set includes, in a structured representation, the prompt sentence, selected indicator records, summary statistics, and region constraints.

The server structures the input information set according to predefined templates that include fields for natural-language context, key-value pairs, tabular numeric summaries, and explicit references to evaluation criteria. This structure allows the generative AI model to receive consistent, machine-generated context that is bound to the exact numeric values used in analysis. This differs from merely copying free-form text into a prompt and improves the determinism and auditability of the model's behavior.

The server may add adjustment conditions derived from attribute information or reaction information of the user. For example, if a user is identified as a specialist, the server adds instructions to increase technical detail in the generated content. If prior user feedback indicates a preference for concise recommendations, the server adds instructions to limit the length and to highlight top-ranked actions. These adjustments are applied through explicit modification of the prompt sentence and associated context before the input information set is sent to the generative AI model.

### E. Generative AI Model Structure and Learning Methods

The server uses a generative AI model implemented as a parameterized neural network, for example, a transformer-based sequence-to-sequence model. The model includes an embedding layer that converts tokens representing text, special control tokens representing structured metadata, and numeric indicator summaries (for example, discretized or encoded values) into dense vectors. The model includes a plurality of transformer blocks, each block comprising a multi-head self-attention mechanism, a feed-forward network, normalization layers, and residual connections. The model outputs a probability distribution over tokens at each generation step, conditioned on the input token sequence and previously generated tokens.

The server, in one embodiment, uses a pre-trained generative model that has been trained on a large generic corpus using a next-token prediction objective. In another embodiment, the server fine-tunes such a pre-trained model using a domain-specific corpus composed of past infrastructure-related reports, applications, and planning documents. During fine-tuning, the server uses a supervised learning procedure that minimizes a loss function such as cross-entropy between predicted tokens and reference tokens. The server updates model parameters by backpropagating gradients through the network and applying a variant of stochastic gradient descent, such as the Adam optimizer.

The server may further adapt the model using reinforcement learning with human feedback.

In this case, the server collects rating information from users regarding the quality of generated proposals. The server uses a reward model that maps generated outputs and context into a scalar reward value and updates the generative model parameters to maximize expected reward, using an algorithm such as proximal policy optimization. This adaptation improves alignment of generated outputs with user preferences and policy objectives.

The server encodes indicator information and evaluation criteria into special input formats that the model has been trained to understand. For example, the server converts tables of numeric indicators into a serial representation with delimiters and control symbols, and the model is trained on many examples of such serializations paired with desired narrative outputs. As a result, the model learns to attend to indicator tokens when generating textual explanations and recommendations. This specific encoding and training scheme allows the generative AI model to reflect detailed quantitative context in its outputs in a way that is not achievable by simple unstructured text prompts.

### F. Automatic Generation of Tabular and Graphical Information

The server, after receiving response information from the generative AI model, parses the generated text to identify section headers, bullet points, and references to indicators or regions. The server then uses the previously computed indicator information and the generated resource allocation plan to construct tabular information. The server applies rules to align rows and columns with region identifiers, time periods, and categories of infrastructure. The server uses the data-frame processing library to assemble a data frame for each table and to export it as a structured table object.

The server generates graphical information such as line charts and bar charts using a visualization library. The server specifies plotting parameters (axes, scales, labels, colors) based on the indicator types and evaluation criteria. For example, the server creates line graphs showing population growth trends over multiple years for each region, and bar charts showing budget execution efficiency by category. The server writes the resulting figures to image files and embeds references to those images in the document structure.

### G. Document Structure Assembly and Technical Improvements

The server maintains format definition information for application documents, report documents, and supplementary materials. The server uses this format definition information to construct a document structure. The document structure includes a hierarchy of sections, subsections, paragraphs, tables, and figures, each with position information and style attributes. The server inserts the model-generated draft information into narrative sections, inserts the auto-generated tables into designated table regions, and inserts the graphs into designated figure regions.

The server thereby creates report documentation that is consistent across narrative, tabular, and graphical content because all components are derived from the same integrated information set, indicator information, and evaluation criteria. This consistency is enforced by machine rules rather than by manual editing, reducing the likelihood of human errors such as mismatched numbers between text and tables.

The server improves computer technology in several ways. First, the server reduces processing time for large heterogeneous datasets by employing normalized schemas, constraint enforcement, and indexed integrated information sets, allowing efficient query execution and indicator computation. Second, the server improves data management accuracy because constraint conditions, referential integrity, and standardized identifiers reduce inconsistent data entries and enable reliable longitudinal analysis. Third, the server improves computational efficiency by performing indicator computations in batch operations using optimized data-frame and SQL processing instead of repetitive manual steps. Fourth, the server reduces communication load by transmitting summarized indicator information and structured prompts rather than sending entire raw datasets to the generative AI model environment.

The generative AI model integration also improves technical performance relative to conventional systems that rely solely on free-form prompts. Because the server constructs a structured input information set, the generative AI model can process relevant numeric and categorical data without being overloaded by extraneous context. This focused context reduces unnecessary token processing, thereby shortening inference time and lowering computational cost. It also enhances output precision, because the model is explicitly conditioned on machine-computed indicators and evaluation criteria.

### H. Distinction from Mere Automation of Human Tasks

The server does not simply automate human document drafting. The server implements algorithmic steps that are not typically performed manually, such as automatic normalization of heterogeneous identifiers, enforcement of database constraints over multi-source data, efficient computation of a large set of indicators across multiple periods and regions, and automatic construction of model-consumable, structured input information sets. The server further exploits neural network-based generative inference that integrates structured indicators into text generation in a consistent machine-understandable representation.

The generative AI model uses, internally, a high-dimensional parameter space and attention mechanisms that enable it to weight different indicator tokens when generating content. This differs from human reasoning in that the model applies mathematically defined attention weights, gradient-based parameter adjustments, and statistical pattern matching learned from large-scale corpora. The system, therefore, performs operations that are not merely human drafting replicated by a computer, but are instead highly parallel, numeric-and-symbolic computations that enhance the capacity of the computing system to handle scale, complexity, and consistency beyond human capability.

### I. Alternative Embodiments and Variations

The server, in another embodiment, executes all indicator computations entirely within the database using SQL window functions and stored procedures, thereby offloading more processing into the database engine and further reducing data transfer between memory spaces. In another embodiment, the terminal, rather than the server, performs initial analysis using local processing power and only transmits aggregated indicator data to the server for integration with the generative AI model pipeline.

The server, in another embodiment, employs different generative AI architectures such as recurrent neural networks with attention, encoder-decoder networks, or hybrid symbolic-neural architectures. The server may also use different learning strategies, such as curriculum learning for gradually increasing complexity of training examples or data augmentation techniques to generate synthetic indicator-context pairs for more robust training.

The server, in a further embodiment, includes a module that automatically compares generated resource allocation plans to historical execution records and computes discrepancy indicators. These discrepancy indicators are stored as additional indicator information and are used in subsequent iterations to refine evaluation criteria and to adjust prompt sentences. For example, the server may automatically modify a prompt sentence to include a request such as:

“Given that previous plans showed a 20% under-execution rate in certain regions, please propose adjustments that reduce future under-execution while maintaining overall equity between regions.”

These variations continue to rely on the same fundamental technical structures: integrated normalized datasets, constraint-managed storage, explicit indicator computation, structured AI input construction, and rule-based document assembly. By coupling these elements, the system achieves measurable technical effects such as improved processing speed, higher consistency of outputs, reduced data errors, and decreased computational and communication overhead, thereby providing an improvement to computer-centric technology rather than merely implementing a business or administrative procedure.

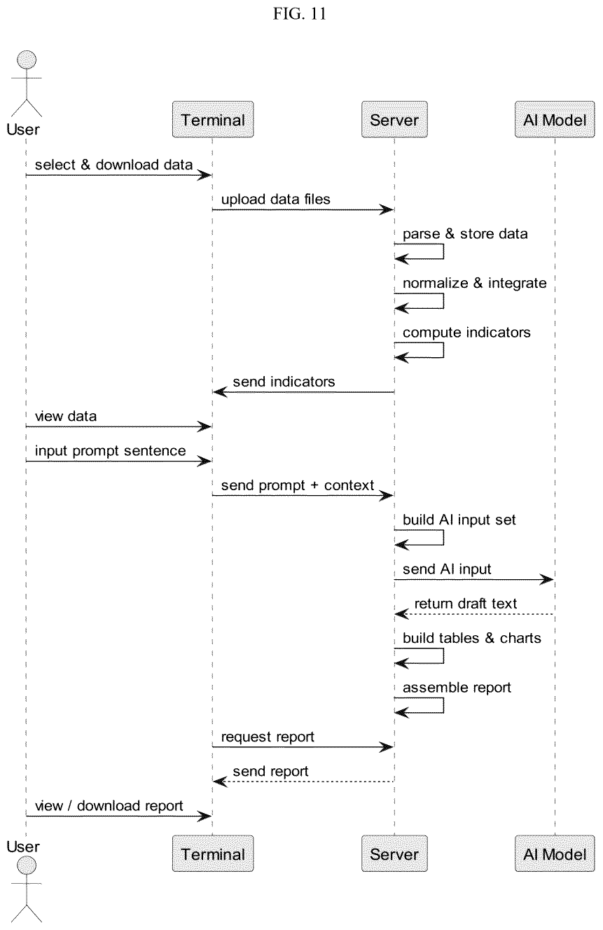

The following describes the processing flow using FIG. 11.

### Step 1:

The user operates the terminal to acquire raw data files. The user accesses web sites of public entities and non-public entities using a web browser executed on the terminal, and selects and downloads structured information such as population statistics, budget records, and market indicators in CSV or spreadsheet formats. The input in this step is network-delivered files provided by external servers, and the output is a set of structured data files stored in the file system of the terminal. The terminal writes each downloaded file to a designated directory and maintains metadata such as file name, download time, and source URL to be used in subsequent steps.

### Step 2:

The terminal transmits the acquired data files to the server. The terminal reads the structured data files from its local storage and sends them to an upload endpoint provided by the server via a secure network protocol. The input in this step is the set of stored CSV and spreadsheet files, and the output is a set of uploaded payloads received and acknowledged by the server.

The terminal embeds file contents and basic descriptors in a request message, and the server writes the raw files into a temporary storage area and registers a record in an upload-log table that associates each file with the user and time of upload.

### Step 3:

The server imports the uploaded files into a relational database. The server parses each file using a parser module, converts the rows into typed records, and maps source column names to internal attribute names according to a configuration schema. The input in this step is the set of uploaded raw files and the schema configuration, and the output is a set of populated base tables storing public-entity and non-public-entity structured information. The server performs data type conversion, such as converting text representations of numbers into numeric fields and date strings into date fields, and applies constraint checks to discard or log records that violate required formats.

### Step 4:

The server normalizes identifiers and units across the base tables. The server reads the imported tables and applies mapping rules to convert heterogeneous region codes, organization codes, and category labels into canonical identifiers stored in master tables. The input in this step is the set of base tables and mapping rules, and the output is updated tables in which identifier fields are replaced or supplemented with canonical codes. The server also standardizes measurement units by multiplying or dividing numeric values according to unit conversion parameters, thereby ensuring that all values for a given attribute are in a single unit system.

### Step 5:

The server constructs an integrated information set. The server executes join operations between the normalized base tables based on common keys such as canonical region identifier and time period. The input in this step is the set of normalized base tables and join conditions, and the output is an integrated table or view that aggregates population, budget, and private-indicator data for each region and period. The server creates indexes on key columns in the integrated table and stores the resulting structure so that later queries can access multi-source data through a single consistent interface.

### Step 6:

The server computes indicator information from the integrated information set. The server executes aggregation and window functions over the integrated table to calculate change rates, ratios, and per-unit metrics. The input in this step is the integrated information set and parameter definitions for each indicator, and the output is an indicator table containing, for each region and period, computed values such as population growth rate, budget execution ratio, and investment per capita. The server groups records by region and orders them by time period to compute differences and percentages, and then writes these computed values into dedicated indicator records with type identifiers.

### Step 7:

The server defines evaluation criteria based on the computed indicators. The server receives configuration parameters or default rules that specify thresholds, target values, and weights for combining different indicators. The input in this step is the indicator table and the evaluation-criteria configuration, and the output is a set of stored evaluation-criteria records and, optionally, composite scores for each region and period. The server applies mathematical operations such as weighted sums and normalization to combine multiple indicator values into composite metrics, and stores these metrics in a criteria table that can be referenced in later analysis.

### Step 8:

The terminal retrieves indicator information and evaluation criteria for inspection by the user.

The terminal sends a request specifying selected regions and periods, and the server responds with the corresponding indicator and criteria records. The input in this step is the selection information from the user and the stored indicator and criteria data, and the output is a rendered display on the terminal that shows tables and graphs summarizing the computed metrics. The terminal uses a data-frame processing module and visualization tools to present line charts, bar charts, and summary tables so that the user can understand trends and relative performance.

### Step 9:

The user formulates a prompt sentence for the generative AI model using the terminal. The user, after viewing the indicators and evaluation criteria, inputs a natural-language instruction that describes the desired type of recommendation or plan. The input in this step is the user's planning intent and understanding of the displayed data, and the output is a specific prompt sentence stored by the terminal. Examples of the prompt sentence include:

“Using the provided indicators for population growth, budget efficiency, and investment per capita, please generate a three-year infrastructure investment plan that maximizes social capital development while respecting the specified annual budget limits for each region.” and

“Please generate proposals to optimize next year's budget allocation for road, water, and public transportation infrastructure, based on the provided population growth rates and budget efficiency indicators.”

### Step 10:

The terminal transmits the prompt sentence and selection context to the server. The terminal packages the prompt sentence together with identifiers of regions, periods, and indicator types into a request message addressed to an AI-input construction module on the server. The input in this step is the prompt sentence and associated selection metadata, and the output is a received message stored in a request queue on the server. The terminal ensures that the message includes references to the user and session so that the server can retrieve matching indicator records for that particular context.

### Step 11:

The server constructs a structured input information set for the generative AI model. The server queries the indicator tables and evaluation-criteria tables using the region and period selections and formats the retrieved values into a structured representation that includes headers, key-value lists, and short textual summaries. The input in this step is the context message from the terminal and the stored indicators and criteria, and the output is a structured input information set that encapsulates the prompt sentence, summarized numeric data, and evaluation rules. The server may also append adjustment conditions derived from user profile or feedback, which are encoded as additional instructions in the natural-language portion of the input information set.

### Step 12:

The server transmits the structured input information set to the generative AI model and receives response information. The server uses an AI-client library to send the combined prompt sentence and structured context to a generative AI inference endpoint and waits for the model to generate an output sequence. The input in this step is the structured input information set, and the output is response information that includes generated draft text describing proposals, justifications, and multi-period resource allocation plans. The server receives the token sequence from the model, decodes it into text, and segments it into logical sections according to delimiters and headings present in the generated content.

### Step 13:

The server generates tabular information from the response information and indicator data.

The server analyzes the generated draft text to identify references to regions, periods, and allocation values, and combines these references with the underlying numeric indicators and evaluation criteria. The input in this step is the model-generated draft text and the indicator and criteria tables, and the output is a set of structured tables that align rows and columns with specified regions, categories, and time periods. The server uses a data-frame processing library to construct these tables and ensures that every numeric value appearing in the tables is consistent with the previously computed indicator values or with explicit allocation numbers present in the model output.

### Step 14:

The server generates graphical information based on the indicator information and resource allocation plan. The server selects appropriate chart types for each indicator and plan dimension and uses a visualization library to render graphs such as time-series lines and category-based bar charts. The input in this step is the indicator table, any computed allocation values, and plotting configuration parameters, and the output is a set of image objects or vector graphics representing the charts. The server sets axis labels, legends, scales, and color schemes to match the evaluation criteria and to be consistent with document-format definitions.

### Step 15:

The server assembles report documentation using the draft text, tabular information, and graphical information. The server retrieves format definition information for the target type of document (for example, application document or report document) and constructs a document structure including sections for introduction, methodology, analysis, and recommendations. The input in this step is the model-generated draft text, the generated tables and graphs, and the format definition information, and the output is a complete report document in a chosen file format. The server inserts paragraphs into narrative sections, positions tables in designated table sections, and embeds graphs in figure sections, and then stores the resulting document in a document repository.

### Step 16:

The terminal provides the generated report documentation to the user. The terminal requests a list of available documents from the server, receives metadata describing each generated report, and allows the user to select and download specific files. The input in this step is the user's selection of document type and period, and the output is the presentation and delivery of the generated report file to the terminal's storage or viewer. The terminal may display the document in a viewer application so that the user can review the automatically generated narrative, tables, and graphs, and optionally provide feedback that can be used as reaction information in subsequent runs.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information processing systems that utilize public data and private data for policy making or risk assessment suffer from multiple technical limitations in how data is integrated, analyzed, and transformed into actionable outputs. First, existing systems typically treat heterogeneous data sources, such as public statistical data and private sensor data, as separate datasets and rely on manual or ad hoc integration. As a result, time information and location information are not consistently normalized or aligned, causing loss of temporal and spatial resolution and reducing the accuracy and reliability of downstream analysis. This leads to inefficient use of storage structures, increased processing latency for large-scale time-series and spatial data, and difficulty in maintaining a coherent data model for continuous retraining of prediction models.

Second, many systems that perform prediction using machine learning operate as one-off or static pipelines. They often do not provide an integrated mechanism to generate feature information and teacher information in a unified way for both historical data and newly incoming data. Consequently, prediction models cannot be easily updated or retrained with feedback data such as actual countermeasure-implementation content and performance information received from user terminals. This results in degradation of model performance over time, inability to adapt to changing data distributions, and limitations in continuously improving resource allocation or other operational decisions.

Third, with respect to generation of report materials, application materials, and supplementary materials, conventional systems frequently require human experts to manually interpret complex prediction outputs and evaluation indicators. Even where natural language generation is used, the systems typically feed raw numerical data directly to a generative model without a structured prompt sentence that encodes analysis-result data, evaluation criteria, document-structure constraints, and presentation-target attributes in a consistent manner. This often produces inconsistent document quality, lack of alignment with predetermined formats, and additional manual post-editing. Furthermore, such systems rarely incorporate policy-related evaluation indicators and execution indicators derived from time-series and spatial predictions into the generative pipeline in an automated fashion.

Fourth, existing notification mechanisms to user terminal devices are often loosely coupled with the predictive analytics pipeline. Notifications may be triggered by simple threshold rules or static schedules, without leveraging region-specific, time-specific event-occurrence probabilities and event-risk indices output by a trained prediction model. As a consequence, the timing and content of notifications are not optimized, and feedback information about actual countermeasures implemented by users may not be systematically captured or appended to the integrated information for model improvement. This weakens the technical integration between front-end user interactions and back-end predictive modeling and leads to inefficient utilization of computing resources and network bandwidth.

Accordingly, there is a technical need for an improved information processing system that (i) performs consistent preprocessing and integration of multiple types of public information and multiple types of private information based on time and location, (ii) constructs and updates prediction models using unified feature information and teacher information, (iii) automatically derives evaluation criteria and analysis-result data suitable for policy or resource planning, (iv) generates structured prompt sentences to control a generative information-processing model so as to obtain formatted report materials with reduced manual intervention, and (v) tightly couples notification delivery and feedback capture with the prediction and retraining pipeline. By addressing these issues, the invention aims to improve the efficiency, scalability, and accuracy of computer-implemented data processing and document generation, and to enhance the technical performance of systems that transform heterogeneous data into actionable information.

The specific processing by the specific processing unit 290 of the data processing device 12 in Application Example 1 is realized by the following means.

The present invention provides a server comprising a processor and a memory storing instructions that, when executed by the processor, cause the processor to acquire multiple types of public information and multiple types of private information via a communication network, to perform preprocessing on the acquired public information and private information based on time information and location information, and to integrate the preprocessed information into a storage structure as integrated information; to generate, from the integrated information, feature information including time-series information and spatial information, to generate teacher information indicating presence or absence or frequency of occurrence of a future event, and to construct a prediction model by using a machine learning algorithm; to convert newly acquired public information and private information by performing a processing operation identical to the feature-information generation, to input the converted information into the prediction model, and to calculate, for each area and for each time period, an event-occurrence probability or an event-risk index; to generate, on the basis of the calculated event-occurrence probability or the event-risk index, evaluation indicators and execution indicators related to resource allocation, patrol activity, monitoring-device placement, lighting-equipment placement, or other countermeasures, and to determine evaluation criteria including the evaluation indicators and the execution indicators; to aggregate the evaluation criteria and the event-occurrence probability or the event-risk index, to generate statistical values, graphical data, and structured data, and to generate analysis-result data including the statistical values, the graphical data, and the structured data; to generate a prompt sentence including an input sentence that includes the analysis-result data and an instruction sentence that includes a creation policy for a policy explanation or a funding-application explanation based on the evaluation criteria; to input the prompt sentence into a generative information-processing model, to acquire natural-language text from the generative information-processing model, and to automatically generate, based on the natural-language text, a report material, an application material, or a supplementary material that conforms to a predetermined format; to generate countermeasure information, based on the evaluation criteria or the execution indicators, as notification information for a user terminal apparatus, and to transmit the notification information to the user terminal apparatus; and to append, to the integrated information, countermeasure-implementation content and performance information acquired from the user terminal apparatus, and to use the appended information for retraining or updating of the prediction model. This enables improvement of computer technology by providing an integrated, machine-executable pipeline that consistently preprocesses heterogeneous data, constructs and updates prediction models with feedback, generates structured prompts for a generative information-processing model to produce formatted documents with reduced manual intervention, and tightly couples predictive analytics with notification delivery and feedback acquisition, thereby enhancing processing efficiency, scalability, and accuracy of the overall information processing system.

The term “public information” refers to information that is made available by a governmental or public-sector entity, typically including statistical data, event records, geographic data, or other datasets that can be accessed via a public interface or data portal.

The term “private information” refers to information that is held by a non-governmental or private-sector entity, including sensor data, transaction data, or operational logs, and that is not generally published as open data but can be accessed under specific conditions or agreements.

The term “communication network” refers to any wired or wireless data transmission infrastructure, including local area networks, wide area networks, and packet-switched networks, that enables electronic devices to exchange digital information.

The term “time information” refers to data indicating a point in time or a period of time, expressed for example as a timestamp, date, or time interval, and used for aligning or indexing records along a temporal axis.

The term “location information” refers to data indicating a physical position or area, expressed for example as coordinates, region identifiers, addresses, or grid identifiers, and used for aligning or indexing records along a spatial axis.

The term “preprocessing” refers to a sequence of computational operations performed on raw data, including cleaning, normalization, transformation, aggregation, and encoding, to make the data suitable for storage, analysis, or input to a prediction model.

The term “storage structure” refers to a logical or physical arrangement for storing digital data, such as a database schema, table, file, or data object, that supports retrieval, update, and association of integrated information.

The term “integrated information” refers to information obtained by combining multiple types of public information and multiple types of private information, aligned and normalized with respect to time information and location information, and stored in a unified storage structure.

The term “feature information” refers to a set of derived values computed from integrated information, including time-series elements and spatial elements, which are used as explanatory variables or inputs to a machine learning algorithm.

The term “teacher information” refers to supervisory information or target values that indicate presence or absence or frequency of occurrence of an event to be predicted, and that are used for training or supervising a prediction model.

The term “event-occurrence probability” refers to a numerical value between a minimum and a maximum, output by a prediction model, that represents a likelihood that a specified event will occur in a specified area during a specified time period.

The term “event-risk index” refers to a scalar or multidimensional value derived from prediction outputs and related data, representing a degree of risk associated with occurrence of a specified event in a specified area and time period.

The term “prediction model” refers to a computational model that is constructed by a machine learning algorithm using feature information and teacher information, and that outputs an event-occurrence probability or an event-risk index when presented with new feature information.

The term “machine learning algorithm” refers to a computer-implemented procedure that automatically adjusts internal parameters of a model based on feature information and teacher information, so as to approximate a mapping from inputs to outputs for prediction or classification.

The term “evaluation indicator” refers to a quantitative or qualitative measure derived from event-occurrence probabilities or event-risk indices, indicating a performance or status related to policy objectives, resource allocation, or operational goals.

The term “execution indicator” refers to a quantitative measure specifying a level, schedule, or intensity of a countermeasure to be carried out, such as a planned number of patrols, devices, or other resources deployed within a given area and time period.

The term “evaluation criteria” refers to a set of conditions, thresholds, or rules that include one or more evaluation indicators and execution indicators, and that are used to assess or guide decision-making regarding countermeasures or policies.

The term “resource allocation” refers to the assignment or distribution of limited computational, human, or physical resources, such as personnel, equipment, or budget, among competing tasks, regions, or time periods based on evaluation criteria.

The term “patrol activity” refers to movement or presence of monitoring personnel or mobile devices along predefined or dynamically assigned routes, performed for the purpose of observation, deterrence, or rapid response.

The term “monitoring-device placement” refers to spatial arrangement or installation planning of devices capable of sensing or recording phenomena, such as imaging devices, acoustic sensors, or other detectors, within one or more regions.

The term “lighting-equipment placement” refers to spatial arrangement or installation planning of illumination devices, such as streetlights or area lights, within one or more regions in order to affect visibility or safety-related conditions.

The term “statistical values” refers to numerical summaries derived from one or more datasets, such as totals, averages, variances, percentiles, or other measures, used to characterize distributions or relationships.

The term “graphical data” refers to data used to represent information in a visual form, including charts, graphs, maps, or diagrams, encoded in a manner suitable for display or embedding in a document.

The term “structured data” refers to data organized according to a predefined schema or format, such as table structures, key-value records, or hierarchical objects, allowing systematic access and processing by a computer program.

The term “analysis-result data” refers to data that summarizes outputs of computational analysis, including statistical values, graphical data, structured data, and other derived information used to describe or support conclusions.

The term “prompt sentence” refers to a text sequence provided as input to a generative information-processing model, including one or more input sentences and instruction sentences, and designed to condition or control the content and style of the model's output.

The term “input sentence” refers to a portion of the prompt sentence that includes analysis-result data or other factual information to be reflected in the output of a generative information-processing model.

The term “instruction sentence” refers to a portion of the prompt sentence that specifies constraints, policies, formatting requirements, or stylistic guidelines for the natural-language text to be generated by a generative information-processing model.

The term “generative information-processing model” refers to a trained computational model that receives text or other data as input and generates new natural-language text or other content as output based on learned patterns.

The term “natural-language text” refers to character strings or tokens that express information in a human language, such as sentences, paragraphs, or complete documents, generated or processed by a computer system.

The term “report material” refers to a document or digital content that explains analysis results, evaluation criteria, or countermeasures, formatted according to predetermined layout or style rules for reporting purposes.

The term “application material” refers to a document or digital content prepared for submission to an external entity, such as a funding body or regulatory organization, including descriptions of objectives, evaluation criteria, and expected outcomes.

The term “supplementary material” refers to additional document content or data that complements a main report material or application material, such as appendices, detailed tables, or explanatory notes.

The term “predetermined format” refers to a set of structural and stylistic constraints defining layout, section organization, headings, and element ordering for a document or digital content.

The term “user terminal apparatus” refers to an electronic device operated by a user, such as a handheld device, a stationary terminal, or a robotic unit, that can receive notification information from the server and transmit feedback information to the server.

The term “notification information” refers to message data transmitted from the server to a user terminal apparatus, including countermeasure information, evaluation indicators, or alerts associated with specific regions and time periods.

The term “countermeasure information” refers to content describing recommended or scheduled actions to address a predicted event risk, including actions derived from evaluation criteria or execution indicators.

The term “countermeasure-implementation content” refers to data indicating which countermeasures were actually executed, in which area, and at what time, as reported from a user terminal apparatus.

The term “performance information” refers to data describing outcomes, effectiveness, or operational results of implemented countermeasures, including observed incident counts, compliance levels, or measured changes in risk indicators.

The term “retraining” refers to a process in which a prediction model is trained again or further adapted using updated integrated information, including newly appended feedback data, in order to improve or maintain performance.

The term “updating of the prediction model” refers to any modification of parameters, structure, or associated preprocessing components of a prediction model based on new data, feedback, or evaluation results.

In one embodiment, a server executes a program that implements the claimed system using standard computing hardware and software components. The server includes at least one central processing unit, a main memory, a non-volatile storage device, and a network interface. The server runs an operating system such as a general-purpose server operating system and executes application programs written, for example, in a high-level language such as Python. The server uses data processing libraries such as a tabular-data processing library, a numerical computation library, and a machine learning library, and uses a database management system such as a relational database system to store integrated information and model-related metadata. The server communicates with one or more user terminals through a communication network such as the Internet or a wireless network.

The server stores, in the non-volatile storage device, program modules including a data acquisition module, a preprocessing and integration module, a feature and label generation module, a prediction model training module, a prediction inference module, an evaluation-criteria generation module, a generative AI interface module, a notification generation module, and a feedback integration module. The server loads these modules into the main memory and executes them under control of the processor. Each module is implemented to perform specific data transformations and computations using the aforementioned software libraries.

The server acquires multiple types of public information and multiple types of private information via the network interface. The server typically accesses public information through an open-data application programming interface or file download interface provided by a public-sector entity. For example, the server may download comma-separated-value files or JavaScript Object Notation files that contain crime incident records, demographic statistics, budget figures, or infrastructure inventory. The server accesses private information through authenticated connections to data stores operated by private-sector entities, such as databases containing sensor-derived metrics or logs of monitoring devices. In some implementations, the server also acquires metadata referring to image or video data stored on a network-attached storage device or an object storage service.

The server performs preprocessing on the acquired public information and private information based on time information and location information. The server uses the tabular-data processing library to parse time stamps into internal time objects, convert all time stamps to a common time zone, and normalize different time granularities to a uniform interval, such as 15 minutes or one hour. The server encodes location information as geographic coordinates or as discrete grid identifiers by applying a geocoding function or a map-projection function. The server then performs data cleaning operations, including removal of records with invalid coordinates, interpolation of short gaps in time-series variables, and replacement of missing measurement values according to predefined rules. These preprocessing operations are defined as deterministic, reusable functions, so that both historical data and newly acquired data are transformed in an identical manner. This consistency in preprocessing improves the technical reliability and comparability of time-series and spatial data, and reduces errors that would arise from ad hoc human processing.

The server integrates the preprocessed public information and private information into a storage structure. Specifically, the server writes the cleaned and normalized data into relational tables in the database management system, where each table row is indexed by a combination of a time interval identifier and a spatial unit identifier. The server constructs foreign-key relationships to associate different types of measurements, such as counts of past events, sensor-derived crowd metrics, and demographic indicators, to the same time-space index. The server also maintains separate tables for model configurations, evaluation indicators, execution indicators, and user feedback. By using this unified storage structure, the server can efficiently query and update large volumes of spatiotemporal data. This structured integration reduces disk I/O and query complexity compared to unstructured log or file-based storage, thereby improving data access speed and scalability.

The server generates feature information and teacher information from the integrated information. The server uses the numerical computation library to compute derived variables, such as rolling averages of past event counts, time-of-day encodings, day-of-week encodings, holiday flags, and aggregated sensor metrics per spatial unit and time period. The server encodes categorical variables into numerical vectors using one-hot encoding or similar schemes provided by the machine learning library. The server defines teacher information for supervised learning by shifting future event counts backward in time. For example, for each spatial unit and time interval, the server labels whether at least one event occurs in the subsequent interval, and uses this label as a binary teacher value. The server may alternatively use the number of events in a future interval as a numeric teacher value. This programmatic generation of teacher information ensures that the prediction task is defined consistently across the entire dataset and enables the prediction model to learn relations between the features and future events.

The server constructs a prediction model by using a machine learning algorithm. In one embodiment, the server uses a gradient-boosted decision tree model implemented in the machine learning library. The server defines hyperparameters such as the number of trees, maximum tree depth, learning rate, and subsampling ratio. The server splits the integrated dataset into a training portion and a validation portion based on time, so that past data are used for training and more recent data are used for validation. The server trains the prediction model by repeatedly fitting trees to the residuals between predicted and true labels, using a loss function such as binary cross-entropy or mean squared error. The server updates model parameters according to the algorithmic rules of the gradient boosting procedure. By optimizing the model on historical data, the server obtains a trained prediction model that can output an event-occurrence probability or an event-risk index when provided with feature information.

In another embodiment, the server uses a neural network as the prediction model. For example, the server constructs a feedforward neural network having an input layer whose dimension equals the number of features, multiple hidden layers with a predetermined number of units per layer, and an output layer with either one unit for binary classification or multiple units for multi-category risk estimation. The server selects activation functions such as rectified linear units for the hidden layers and a sigmoid or softmax function for the output layer. The server trains the neural network using stochastic gradient descent or a variant such as Adam optimization, with a loss function such as binary cross-entropy. The server computes gradients of the loss with respect to network weights by backpropagation, and updates the weights at each training step using mini-batches of feature and teacher data. The server may also apply regularization techniques such as dropout or weight decay to prevent overfitting. This neural network implementation enables the server to model complex nonlinear interactions among spatiotemporal features and to improve prediction accuracy over simpler linear models.

The server calculates event-occurrence probabilities or event-risk indices by applying the trained prediction model to new feature information. The server periodically acquires new public information and private information, applies the same preprocessing and feature generation procedures as described above, and passes the transformed features through the prediction model. The server obtains, for each spatial unit and time period, a probability value or a risk score that quantifies the likelihood of future events. The server stores these outputs in a prediction-result table, with fields specifying the time, location, model identifier, and predicted value. This structured representation allows efficient retrieval of predictions for further processing and for notification generation, and reduces redundant computation by reusing stored prediction results across multiple downstream modules.

The server generates evaluation indicators and execution indicators based on the prediction results. The server aggregates event-occurrence probabilities or event-risk indices over longer time horizons or over administrative districts, using the tabular-data processing library. For example, the server computes the average risk per day and per district, the maximum risk within a particular week, or the expected number of events by summing probabilities. On the basis of these aggregated values and predefined rules, the server computes evaluation indicators such as target risk thresholds, risk reduction ratios, and resource utilization metrics.

The server also computes execution indicators that specify operational measures, such as the number of patrol units to be deployed per time interval, the number of monitoring devices to be installed or repositioned, and the number of lighting devices to be activated or upgraded.

The server stores these indicators as structured records, linked by foreign keys to the relevant time and location indices, which allows other modules to reference them efficiently.

The server generates analysis-result data by combining the evaluation criteria with the prediction results. The server calculates statistical values, including averages, medians, variances, and quantiles of risk indices, and generates graphical data such as charts and heatmaps by using a plotting library. The server encodes these graphical data as image files or vector-graphics objects and stores corresponding metadata in the database. The server also produces structured data representations, such as tables of district-level risk and recommended measures. By precomputing these representations, the server reduces the computational burden during report generation and allows rapid retrieval of relevant components when composing prompt sentences and documents.

The server generates a prompt sentence for a generative AI model by combining input sentences and instruction sentences. The server constructs input sentences that embed analysis-result data in a textual form, such as “In Region X, the predicted number of events next week is 20, with the highest risk from 18:00 to 23:00 in the commercial area.” The server constructs instruction sentences that specify requirements for the generated document, such as expected length, target reader, desired level of detail, and formatting constraints corresponding to a predetermined report or application template. The server concatenates these components into a single prompt sentence, ensuring that the prompt sentence follows a consistent structure that the generative AI model can interpret reliably.

For example, the server may generate the following prompt sentence:

“You are an expert policy analyst for urban safety planning. The server has analyzed municipal open data and private surveillance metrics using a data processing library and a machine learning library. In District B, the model predicts 20 incidents next week, with peak risk between 18:00 and 23:00 in the shopping area. After installing 15 additional lighting devices, the predicted risk decreased by 25%. Based on these results, write a detailed explanation of current risks, propose at least four concrete countermeasures, and define at least three quantitative key performance indicators (for example, patrol frequency, monitoring-device coverage, and lighting density). Then explain how these key performance indicators support an application for a comprehensive infrastructure improvement grant. Use clear, formal language suitable for a government report.”

The server inputs the prompt sentence into a generative AI model, which may be implemented as a large language model running on the same server or on a remote inference service. The server sends the prompt sentence through an application programming interface that accepts text input and returns generated natural-language text. Internally, the generative AI model comprises a neural network, typically a transformer-based architecture, with multiple layers of self-attention and feedforward sublayers. The model uses parameters trained on large corpora of text, and transforms the prompt sentence into an internal representation. The model generates output tokens sequentially, conditioned on the previous tokens and the embedded prompt, and applies a decoding method such as beam search or nucleus sampling to produce coherent text. The server receives the generated text, stores it in the database, and applies post-processing rules, such as enforcing section headings, limiting maximum length, or inserting tables and figures at predefined locations. This structured interaction with the generative AI model improves consistency and relevance of generated documents compared to unstructured prompts, and reduces the need for human editing. The server automatically generates report materials, application materials, or supplementary materials that conform to predetermined formats. The server uses a document-generation library to assemble the natural-language text, graphics, and tables into a file, such as a document or portable document file. The server maps sections of the generated text to template fields and inserts graphical data in designated positions. By automating this assembly process, the server reduces variance in document layout and improves reproducibility across multiple runs. The server can also store template versions and track document revisions, enabling robust document lifecycle management.

The server generates notification information based on evaluation criteria or execution indicators, and transmits the notification information to user terminal apparatuses. The server creates concise messages summarizing the predicted risks and recommended actions for specific locations and time periods. For example, the server may create a notification containing “High risk between 20:00 and 24:00 in grid cell 43; recommended patrol frequency: five patrols per hour.” The server encodes this content as a payload for a push-notification service or for a message queue, and sends it to those terminals that are registered for the corresponding region or function. The server logs delivery status and retries failed deliveries according to defined rules. By linking notifications directly to outputs of the prediction and evaluation modules, the server ensures that notifications reflect up-to-date computational results and avoids ad hoc manual triggering of alerts.

The terminal receives notification information from the server and presents the information to a user. The terminal includes a processor, a display, an input interface, a memory, and a communication interface. The terminal runs a client application that subscribes to push notifications or polls a server endpoint. Upon receiving notification information, the terminal stores the content in a local data structure, such as a lightweight database, and displays the information on the screen together with auxiliary context such as a map, time range, and icons representing recommended actions. The terminal may also allow the user to filter notifications by region, time, or risk level.

The user views the notifications on the terminal and may decide to perform countermeasures.

The user may navigate within the client application to see more detailed information, including the underlying evaluation indicators and execution indicators. The user may also access summary reports generated by the generative AI model through the terminal.

The terminal transmits feedback information to the server. When the user has implemented countermeasures, the user enters information such as the type of countermeasure, the location, the time, and the extent of resources used into an input form on the terminal. The terminal packages this information as structured data and sends it to the server via the communication network. In this way, the system obtains explicit data about which recommendations were followed and what actions were taken, without relying on manual aggregation or offline reporting.

The server integrates the feedback information into the integrated information. The server associates the countermeasure-implementation content and performance information with related prediction records via time and spatial indices. The server updates the integrated tables to include these new fields as additional features for future training. The server then uses the updated dataset to retrain or update the prediction model. For example, the server may extend the feature vectors to include indicators such as “patrol density” or “lighting increase” and retrain the gradient-boosted model or neural network to learn how the presence of these measures affects future event occurrence. By closing this feedback loop, the server adapts the model to real-world outcomes and improves prediction accuracy over time.

This system improves computer technology in several technical aspects. First, the server enforces a unified spatiotemporal indexing and preprocessing pipeline that is applied identically to historical and real-time data, which significantly reduces inconsistencies and errors due to heterogeneous formats. This design results in improved data management performance, including reduced storage redundancy and faster retrieval of integrated records via indexed time-space keys. Second, by automatically generating feature and teacher information with deterministic transformation functions, the server enables efficient batch processing and incremental updates, reducing computational overhead and training time compared to manual feature engineering. Third, the feedback integration mechanism, in which implemented countermeasures are appended and used as additional features, creates a non-traditional training environment in which the model can learn dynamic interaction between measures and outcomes. This produces better-calibrated risk estimates and lowers prediction error, particularly in changing environments.

Furthermore, the structured prompt sentence generation and controlled interaction with a generative AI model are designed as technical mechanisms rather than mere automation of drafting work. The server encodes document-format requirements and target audience attributes into instruction sentences, and merges them with analysis-result data in a consistent schema. This approach allows the generative AI model to operate as a controlled text-generation component within a larger computational pipeline. As a result, the system produces output documents that have predictable structure and content, reducing post-processing complexity and saving computational and human resources. The server also caches intermediate analysis-result data and uses them for multiple prompt generations, reducing redundant repeated analysis and thereby reducing processor load and network traffic to remote generative-model services.

In alternative embodiments, the server may employ different machine learning algorithms and model architectures, such as random forests, support vector machines, recurrent neural networks for time-series modeling, or graph-based neural networks for modeling spatial relationships between regions. The server may adjust loss functions, optimization algorithms, and regularization strategies depending on the characteristics of the data. The server may also vary the structure of prompt sentences, for example by including explicit instructions to generate tabular summaries, bullet lists of countermeasures, or multi-language outputs. The server may interface with different types of user terminals, including fixed control-room consoles, wearable devices, or robotic units that autonomously adjust their routes based on received execution indicators.

Because each of these embodiments shares the common structural elements of integrated spatiotemporal data processing, model-based risk prediction, structured prompt generation, generative AI-based document creation, and feedback-driven model updating, they all provide technical improvements in processing speed, prediction accuracy, data management, and communication efficiency relative to conventional, manually integrated systems.

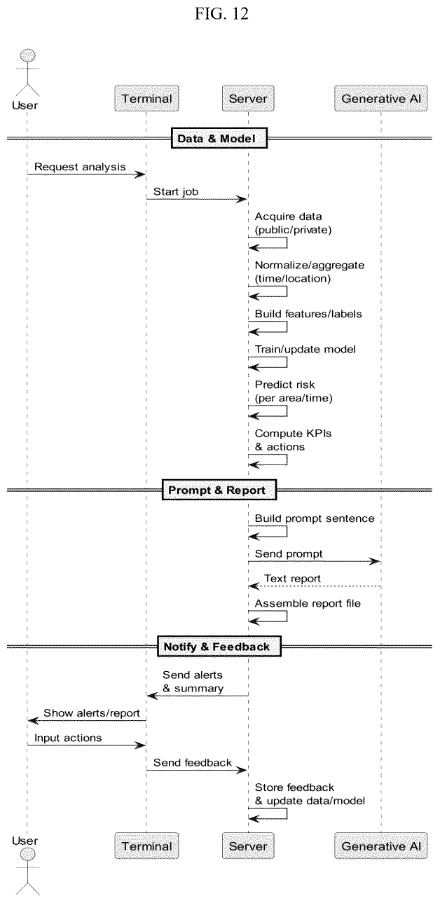

The following describes the processing flow using FIG. 12.

### Step 1:

The server acquires heterogeneous source data.

The server receives, as input, multiple types of public information (for example, open statistical datasets and event logs) and multiple types of private information (for example, sensor-derived metrics and monitoring-device logs) via a communication network. The server uses a network interface and application programming interfaces to download or query these datasets, which may be provided as CSV files, JSON files, or relational database tables. The server writes the raw data into temporary storage in a database. As output, the server produces a set of raw-data records tagged with source type, acquisition time, and original format metadata.

### Step 2:

The server normalizes time and location information.

The server takes, as input, the raw-data records from Step 1. The server parses time stamps into internal time objects, converts them to a unified time zone, and rounds or resamples them into fixed time intervals (for example, 15-minute or 1-hour slots). The server converts location descriptors such as addresses or device identifiers into geographic coordinates or discrete grid identifiers by applying geocoding and mapping functions. The server then replaces original time and location fields with normalized representations. As output, the server generates a time-normalized and location-normalized dataset in which each record is associated with a consistent time interval identifier and a spatial unit identifier.

### Step 3:

The server cleans and aggregates the normalized data.

The server receives, as input, the normalized dataset from Step 2. The server removes records with invalid or missing essential fields, fills acceptable missing values using interpolation or default values, and standardizes units and scales (for example, converting counts to rates per interval). The server groups records by time interval and spatial unit and computes aggregate statistics, such as counts of past events, averages of sensor measurements, and maximum or minimum values. Through these aggregation operations, the server reduces noise and compresses high-frequency logs into representative metrics. As output, the server produces an aggregated spatiotemporal dataset in tabular form, where each row corresponds to a (time interval, spatial unit) pair and contains cleaned and aggregated measurements.

### Step 4:

The server generates feature information and teacher information.

The server takes, as input, the aggregated spatiotemporal dataset from Step 3. The server computes feature information by deriving additional variables: for example, encoding the hour of day and day of week, defining holiday flags, calculating rolling averages of past event counts, and computing differences or ratios between successive intervals. The server also generates teacher information by examining event occurrences in future intervals and labeling each (time interval, spatial unit) record with a binary or numeric target (for example, whether at least one event occurs in the next interval or how many events occur). The server uses deterministic transformations so that the same rules apply across all records. As output, the server produces a feature matrix aligned with a corresponding label vector, which together form a training dataset for a prediction model.

### Step 5:

The server trains a prediction model by using machine learning.

The server receives, as input, the feature matrix and label vector from Step 4. The server splits the dataset into training and validation subsets based on time, ensuring that older data is used for training and more recent data for validation. The server selects a machine learning algorithm, such as a gradient-boosted decision tree or a neural network, and initializes model parameters and hyperparameters. The server repeatedly processes mini-batches of feature and label data, computes a loss function (for example, cross-entropy for classification), calculates gradients or residuals, and updates model parameters according to the algorithm's update rules. The server monitors performance metrics on the validation subset and may adjust hyperparameters. As output, the server generates a trained prediction model together with associated preprocessing parameters (such as scaling and encoding rules), and stores these in a model repository.

### Step 6:

The server applies the trained prediction model to new data.

The server takes, as input, newly acquired public and private information that arrive after the model has been trained. The server passes the new data through the same preprocessing pipeline as in Steps 2 to 4, generating a new feature matrix that is consistent with the training features. The server loads the trained prediction model from the model repository and invokes its inference function on the new feature matrix to compute event-occurrence probabilities or event-risk indices for each (time interval, spatial unit) pair. As output, the server produces a prediction-result dataset containing, for each area and time, a risk value and associated identifiers, and stores this dataset in a prediction-result table.

### Step 7:

The server derives evaluation indicators and execution indicators.

The server receives, as input, the prediction-result dataset from Step 6, together with historical performance metrics and configuration rules. The server aggregates risk values by region, time band, or category, computing summary statistics such as mean risk, peak risk, and expected number of events. The server then applies rule-based or optimization-based computations to transform these summaries into evaluation indicators (for example, risk thresholds, target reductions) and execution indicators (for example, recommended patrol counts, monitoring-device placements, or lighting-equipment adjustments). As output, the server creates structured records describing evaluation criteria, including evaluation indicators and execution indicators associated with specific regions and time periods.

### Step 8:

The server generates analysis-result data for reporting.

The server takes, as input, the evaluation criteria from Step 7 and the underlying prediction-result dataset. The server computes additional statistical values such as variances, percentiles, and trend measures over time. The server generates graphical data, such as charts and heatmaps, by mapping risk and indicator values to visual elements. The server also constructs structured tables that summarize risks and recommended countermeasures per region and time band. The server packages these numerical and visual elements into analysis-result data, tagging each element with identifiers for easy retrieval. As output, the server produces a collection of analysis-result objects (tables, statistics, and graphics) stored in a document-support repository.

### Step 9:

The server constructs a prompt sentence for a generative AI model.

The server receives, as input, selected analysis-result data from Step 8 and document requirements such as target audience, language, and format constraints. The server converts key statistics and indicators into natural-language input sentences that describe the current situation and computed recommendations. The server then constructs instruction sentences that specify how the generative AI model should produce the output, including required sections, length, style, and inclusion of key performance indicators. The server concatenates these input and instruction sentences in a predetermined order and forms a single prompt sentence. As output, the server produces a text string that serves as a structured prompt sentence for the generative AI model.

### Step 10:

The server generates document text using the generative AI model.

The server takes, as input, the prompt sentence from Step 9. The server sends this text to an instance of a generative AI model, which may be hosted locally or on a remote inference service, via an application programming interface. The server receives, as output from the generative AI model, natural-language text such as a draft report, application explanation, or supplementary description. The server parses the generated text, identifies sections and key phrases according to the instructions contained in the prompt sentence, and performs any necessary post-processing such as trimming, section reordering, or insertion of references to tables and figures. As output, the server creates a structured document body that is ready to be combined with graphical data and tables.

### Step 11:

The server assembles formatted report materials.

The server receives, as input, the structured document body from Step 10 and the analysis-result data from Step 8, along with a predetermined document template. The server inserts text paragraphs into designated sections, embeds charts and tables in appropriate positions, and applies formatting rules such as headings, numbering, and captions. The server then outputs a formatted document file, such as a report material or application material, and stores it in a document repository. As output, the server provides a machine-generated document that conforms to required format specifications and incorporates model-derived evaluation criteria and analysis results.

### Step 12:

The server creates notification information for user terminals.

The server takes, as input, the evaluation criteria and execution indicators from Step 7 and the prediction-result dataset from Step 6. The server selects, according to predefined thresholds or priority rules, those regions and time periods for which notifications should be sent. The server composes concise notification messages that summarize key risk values and recommended actions (for example, increased patrol frequency or device deployment). The server associates each notification with destination terminal identifiers based on region or role mapping. As output, the server generates a set of notification payloads ready for transmission to terminals.

### Step 13:

The server transmits notifications to terminals.

The server receives, as input, the notification payloads from Step 12. The server uses communication protocols such as push-notification services, message queues, or direct server-client connections to deliver the payloads to registered terminals. The server encodes the payloads into the required transmission format, sends them through the network interface, and logs the delivery status. As output, the server produces delivery records indicating which terminals have received which notifications, and the terminals receive notification messages containing risk and countermeasure information.

### Step 14:

The terminal displays notifications to the user.

The terminal takes, as input, the notification messages transmitted by the server in Step 13.

The terminal decodes the payload, stores the notification content in a local data structure, and renders a visual representation on the display. The terminal may show a brief alert in a notification bar and a detailed view including region name, time window, risk level, and recommended actions. As output, the terminal provides a user-visible interface that allows the user to perceive system-generated risk assessments and recommended measures.

### Step 15:

The user reviews notifications and reports and decides actions.

The user receives, as input, the information displayed by the terminal in Step 14 and, optionally, accesses the detailed report materials generated in Step 11 through the terminal.

The user interprets the risk levels and execution indicators and determines which countermeasures to implement, such as adjusting patrol schedules, changing monitoring-device positions, or modifying lighting-equipment settings. As output, the user forms decisions and operational plans that will be executed in the real world.

### Step 16:

The terminal collects feedback on implemented countermeasures.

The terminal takes, as input, the user's operation on an input interface where the user records implemented measures, locations, times, and resource usage. The terminal structures this information into a feedback record, including identifiers for region, time interval, and action type. The terminal may validate some fields locally, such as ensuring required fields are filled. As output, the terminal generates a feedback dataset that represents actual countermeasure-implementation content and performance information.

### Step 17:

The terminal transmits feedback to the server.

The terminal receives, as input, the feedback dataset created in Step 16. The terminal establishes a communication session with the server and sends the dataset via a secure protocol. The terminal may queue feedback for later transmission if connectivity is temporary unavailable. As output, the server receives structured feedback records corresponding to real-world countermeasures.

### Step 18:

The server integrates feedback and updates the prediction model.

The server takes, as input, the feedback records transmitted by the terminal in Step 17 and the existing integrated information from Step 3. The server associates each feedback record with corresponding time intervals and spatial units, appending new fields such as implemented measure type, intensity, and timing to the integrated dataset. The server regenerates feature information that now includes variables representing implemented measures, and may recompute teacher information to reflect observed outcomes after implementation. The server then retrains or fine-tunes the prediction model, using the updated feature and teacher data, by repeating the training procedures from Step 5. As output, the server produces an updated prediction model that incorporates the causal impact of countermeasures, thereby improving prediction accuracy and refining subsequent evaluation indicators and notifications.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for preparing application documents and report documents for public programs, such as grant applications and performance reports, require substantial manual effort to collect, integrate, and format heterogeneous data originating from public organizations and private entities. Data related to policies, statistics, budgets, commercial activities, and performance results is often stored in disparate data sources, in different schemas, and with inconsistent levels of granularity. As a result, existing document generation workflows typically rely on manual extraction, manual calculation of evaluation indicators, manual layout into templates, and manual drafting of narrative sections, which leads to high processing cost, long turnaround time, and increased risk of human error.

In addition, conventional document generation tools generally operate on a single, pre-curated dataset and produce static text and graphics. Such tools do not dynamically integrate multiple kinds of structured and unstructured data into a unified schema, do not systematically compute evaluation indicators based on integrated datasets, and do not tightly couple such data processing with automated narrative generation using a generative AI model. As a consequence, it is difficult to automatically create high-quality, data-consistent narrative explanations that accurately reflect underlying indicators and visualizations.

Furthermore, existing systems lack mechanisms for interactive refinement that combine user edits with automated regeneration. When a user modifies or augments content in a draft application or report, conventional tools do not propagate such modifications back into the underlying structured data, do not use such modifications to refine prompts to a generative AI model, and do not selectively re-generate only affected sections while preserving the consistency of the overall document. This results in fragmented workflows in which users must repeatedly copy, paste, and reconcile data and text between multiple tools.

Moreover, region-specific analysis based on both public organizational data and private entity data is not well supported by typical document tools. Conventional systems either ignore regional granularity or require the user to manually select and combine data subsets for each region, which does not scale and is error-prone. They also do not provide a unified mechanism to calculate regional evaluation indicators, generate region-specific visualizations, and embed corresponding explanations into the document automatically.

From the perspective of computer technology, there is a need for an improved data processing and document generation architecture that: (i) transforms heterogeneous public and private data into an integrated data set at the system level; (ii) systematically computes evaluation indicators and related visualization data; (iii) constructs structured prompts for a generative AI model so that narrative text is tightly aligned with computed indicators and visualizations; and (iv) supports an interactive loop in which user modifications are fed back into the structured data and prompt construction logic. Such an architecture would improve the functioning of the computer system itself by enabling more efficient, automated, consistent, and scalable processing of complex, multi-source data into application and report documents.

The specific processing by the specific processing unit 290 of the data processing device 12 in Example 2 is realized by the following means.

The present invention provides a server comprising a processor, a data storage apparatus interface, a visualization apparatus interface, and a communication interface to a terminal apparatus, the processor being configured to acquire, via the data storage apparatus interface, public organization information and private entity information, to integrate plural kinds of acquired data into an integrated data set based on a common item schema, to perform numerical operations and aggregation processing on the integrated data set to calculate evaluation criterion information including evaluation indicators, to format the evaluation criterion information as structured data corresponding to fields of a document template, to extract visualization data from at least one of the integrated data set and the evaluation criterion information and to generate tabular data and graph image data as visualization data, to read the document template indicating a template for an application document or a report document from a storage device and to automatically assign numerical data, character data, and the visualization data to items in the document template based on a correspondence between the items and the structured data, to generate a prompt sentence including at least a part of the integrated data set and the evaluation criterion information and to input the prompt sentence and the structured data into a generative AI model so as to cause the generative AI model to generate explanatory text constituting a narrative portion of the document, to synthesize the explanatory text and the visualization data into the document template to generate a document file in a predetermined document format and to store the document file in an information storage apparatus, and to transmit the document file and the visualization data to the terminal apparatus and, upon reception of modification information and additional information from the terminal apparatus, to update the structured data and the explanatory text based on the modification information and the additional information and to selectively regenerate at least a part of the application document or the report document based on the updated content. This enables an improved computer-based document generation process in which heterogeneous public and private data is integrated and transformed into consistent structured data, evaluation indicators, visualizations, and narrative text that are automatically composed into application and report documents, while supporting interactive refinement through user feedback and selective regeneration, thereby enhancing the efficiency, scalability, and reliability of the underlying data processing and document creation operations performed by the server.

The term “public organization information” refers to information made available by a public body, including data related to policies, statistics, budgets, programs, and other administratively managed records that are published or otherwise accessible for processing by an information system.

The term “private entity information” refers to information held by a non-public body, including data related to commercial activities, customers, projects, performance results, and other records managed by private organizations or individuals.

The term “data storage apparatus” refers to a hardware or virtualized component configured to store digital data, including but not limited to local storage devices, network storage devices, and remote storage services.

The term “integrated data set” refers to a collection of data records obtained by combining plural kinds of heterogeneous data, including public organization information and private entity information, into a unified structure based on a common schema or item definition.

The term “common item schema” refers to a set of item definitions, field names, and data types used to normalize and align heterogeneous data sources so that they can be integrated into a single, consistent data representation.

The term “evaluation criterion information” refers to information that includes one or more evaluation indicators, thresholds, and related computed values used to assess the status, performance, or effect of a project, program, or activity.

The term “evaluation indicator” refers to a computed metric, such as a ratio, rate, index, or score, that quantitatively expresses the progress, efficiency, or outcome of a project, program, or activity based on underlying data.

The term “structured data” refers to data organized according to a predefined schema or format, including key-value structures, tables, and objects, suitable for automatic processing by a template engine or a programmatic interface.

The term “visualization data” refers to data prepared for graphical or tabular representation, including aggregated values, time-series values, categories, and labels that can be converted into charts, graphs, or tables.

The term “tabular data” refers to structured data arranged in rows and columns, suitable for representation as a table in a document, a user interface, or a visualization output.

The term “graph image data” refers to digital image data representing one or more visual elements such as bar charts, line charts, pie charts, or other graphical forms derived from underlying numerical or categorical data.

The term “document template” refers to a predefined document structure that includes layout information, placeholders, and formatting rules for generating an application document, a report document, or other structured documents.

The term “application document” refers to a document prepared for requesting approval, funding, or authorization from a public body or another organization, including grant applications, subsidy applications, and similar request forms.

The term “report document” refers to a document prepared for reporting results, performance, or status to a public body or another organization, including performance reports, outcome reports, and related summaries.

The term “prompt sentence” refers to text information, including instructions, context, and data summaries, that is provided as input to a generative AI model to control or guide the generation of output text.

The term “generative AI model” refers to a machine learning model, such as a language model, that is configured to generate text or other content in response to input data and prompts.

The term “explanatory text” refers to narrative content generated or refined by the generative AI model that describes, explains, or interprets data, indicators, or activities within an application document or a report document.

The term “visualization apparatus” refers to a hardware or software component configured to generate visual representations of data, such as tables or graphs, based on input data sets.

The term “information storage apparatus” refers to a hardware or virtualized storage resource used to store generated document files and related metadata in one or more digital formats.

The term “terminal apparatus” refers to an end-user device, such as a personal computer, a mobile device, or a tablet, configured to communicate with the server, display documents and visualizations, and accept user input.

The term “modification information” refers to information representing changes made by a user to a generated document, including corrections, deletions, and replacements of existing content.

The term “additional information” refers to information newly provided by a user that supplements or extends the automatically generated content, including added explanations, details, or annotations.

The term “selectively regenerate” refers to a process in which only part of an already generated document is re-created or updated, while retaining other parts unchanged, based on updated structured data or user-provided information.

The term “distribution information” refers to information that enables access to a generated document file, including identifiers, file paths, network locations, or links for download or viewing.

In one embodiment, a server implements the claimed system using a general-purpose computing platform. The server includes at least one central processing unit (CPU), a main memory, a nonvolatile storage device such as a solid-state drive, a network interface controller, and a graphics processing unit (GPU). The server executes an operating system, for example a UNIX-like operating system, and executes application programs written in a high-level language such as a scripting language. The server communicates with one or more databases, one or more storage services, and one or more terminal devices over a packet-switched network using a transport protocol.

The server obtains public organization information and private entity information from one or more data storage apparatuses. The server accesses relational databases, such as a structured query language database, or non-relational datastores through a data access library. The server executes query statements to retrieve records containing policy-related data, statistical data, budget data, commercial activity data, performance log data, and other structured records. The server loads query results into main memory as two-dimensional table objects, for example data frame objects provided by a data analysis library. Each data frame includes rows corresponding to records and columns corresponding to fields.

The server transforms the heterogeneous public organization information and private entity information into an integrated data set based on a common item schema. The server maintains a schema definition that maps source field names and types to normalized item names and normalized data types. The server applies column renaming, type conversion, unit normalization, and key alignment operations using data analysis functions. For example, the server converts string representations of dates into internal date-time objects, normalizes monetary amounts to a particular currency, and converts percentage strings to floating-point values. The server joins multiple tables by common key fields, such as region identifiers or project identifiers, to produce a unified table in which rows correspond to combined public and private records. This integrated data structure enables the server to perform subsequent computations using vectorized operations, thereby improving computational efficiency compared to record-by-record processing.

The server computes evaluation criterion information from the integrated data set. The server uses numerical computation libraries to perform aggregation operations, such as summations, averages, standard deviations, ratios, growth rates, and cumulative totals over selected fields. The server defines evaluation indicators as derived columns in the data frame, for example a budget execution rate computed as an executed_amount column divided by an approved_budget column, or a beneficiary-per-unit-cost index computed as a beneficiary_count column divided by a cost column. The server stores evaluation criterion information in structured form, including indicator names, definitions, formulas, and computed values. Because the server uses vectorized matrix operations and optimized numerical libraries, the server reduces the computational time for computing large numbers of indicators over large datasets, and ensures consistent application of formulas across all records, which enhances accuracy and repeatability.

The server generates visualization data from at least one of the integrated data set and the evaluation criterion information. The server groups data by dimensions such as fiscal year, region, or category using group-by operations, and computes aggregate values for those groups. The server forms arrays of x-axis labels (for example, years or region codes) and γ-axis values (for example, amounts or indicator scores). The server passes these arrays to a visualization library to generate tabular data and graph image data. For instance, the server generates bar charts and line graphs by providing numeric arrays and label arrays to drawing functions. The visualization library rasterizes or vectorizes graph objects into image buffers, which the server encodes as image files in formats such as PNG or SVG. The server also converts selected data frames into table representations and exports them as formatted text or embedded images. By generating visualizations directly from the normalized data structures, the server avoids mismatches between numeric values and visual outputs, thereby improving data consistency.

The server reads document templates that define application documents and report documents. The server stores template files in a storage device, for example in a directory or in a network storage service. Each document template includes placeholders corresponding to logical fields, including project title, budget summary, evaluation section, tables, and figure positions. The server loads a template file using a template processing library, parses the template structure, and identifies placeholder tags. The server associates each placeholder with a key in the structured data representing the integrated data set, evaluation criterion information, visualization data, and explanatory text.

The server formats the computed data and the evaluation criterion information as structured data that matches the template schema. The server constructs nested data structures in main memory, for example dictionaries or objects that map logical field names to scalar values, arrays, tables, and image references. The server assigns numeric indicator values, textual labels, and references to graph image data to corresponding template fields. This structuring step positions the data for later injection into the template without requiring additional per-document manual mapping, which reduces processing overhead and avoids human mapping errors.

The server constructs a prompt sentence for a generative AI model using the integrated data set and the evaluation criterion information. The server selects relevant indicator values and summaries, and formats them as textual explanations or compact tabular summaries embedded in the prompt. The server includes instructions specifying document type, style, and required sections. For example, the server may construct a prompt sentence:

“Using the structured data for the 2023 fiscal year grant project, generate a formal application narrative. Describe the project background, objectives, implementation plan, budget details, and evaluation indicators. Align the content with standard public grant application requirements and reference the provided charts and tables where appropriate.”

In another example, after a user has edited a draft evaluation section, the server may construct a refinement prompt sentence:

“Rewrite the following evaluation section in a clear, formal style suitable for a government grant application. Keep all numerical values and indicators unchanged, but improve readability and coherence: [insert user-edited text here].”

The server inputs the prompt sentence and selected structured data into a generative AI model implemented as a trained neural network. In one embodiment, the generative AI model is a transformer-based language model having an encoder-decoder or decoder-only architecture with multiple self-attention layers and feedforward layers. The model maintains token embeddings, positional encodings, and layer-normalization parameters. During inference, the server tokenizes the prompt sentence into token identifiers, retrieves corresponding embeddings, and performs multi-head attention and matrix multiplications on the GPU. The server sets inference parameters such as maximum output length, temperature, and sampling strategy. The model generates a sequence of tokens that the server decodes into text forming an explanatory narrative. By specifying particular evaluation indicators and their relationships in the prompt, the server constrains generation so that the narrative aligns with computed data, thereby improving semantic consistency compared to generic text generation.

The server can use a model that has been trained beforehand on a corpus including administrative texts, technical reports, and structured document examples. During training, the model minimizes a loss function such as cross-entropy between predicted token distributions and ground-truth tokens. The server or a training system updates model weights using a gradient-based optimization algorithm such as stochastic gradient descent with momentum or an adaptive method. Data augmentation techniques, such as synonym replacement and format variation, may be applied to increase robustness. Although training can be performed offline, disclosure of such learning methods clarifies that the model is implemented as a specific neural network architecture with learned weight parameters, rather than as an abstract “black box.”

The server integrates the explanatory text generated by the generative AI model into the document template. The server segments the generated text into logical sections such as background, objectives, implementation plan, and evaluation. The server assigns each segment to a corresponding field in the structured data associated with the template. The server then invokes the template engine to render the document, replacing placeholders with values from the structured data and embedding images for graphs and tables at designated positions. The template engine traverses the template structure and outputs a document file in a predetermined format, such as a word processing file or another office format. The server may further convert this file to a fixed-layout format such as a portable document file using a conversion library or a document conversion service.

The server stores the generated document file and related visualization data in an information storage apparatus. The server maintains metadata for each file, such as project identifier, fiscal year, version number, and access control information. The server generates distribution information, such as a uniform resource locator or a file identifier, and stores it in a database accessible to an application programming interface.

A terminal communicates with the server via a network. The terminal may be a personal computer, a mobile terminal, or another user device including a processor, a memory, a display, and an input interface such as a keyboard or a touchscreen. The terminal receives document files and visualization data from the server through an application protocol and displays the document content and the graphs on its display. The terminal presents input fields that correspond to editable sections of the document, such as narrative explanation fields, justification fields, and comments. The user operates the terminal to review the automatically generated content. The user can modify phrases, correct details, or add context-specific information. The terminal collects the user's input as modification information and additional information and sends it back to the server over the network.

The server receives modification information and additional information from the terminal and updates the underlying structured data. The server associates user edits with corresponding structured fields, ensuring that changes are propagated not only to visible text but also to internal representations used for subsequent computations and prompt construction. The server may perform validation, such as checking length limits or required fields, and then merges the edits into the structured data object. If the user requests refinement of a specific section, the server constructs a new prompt sentence that contains the edited text and additional instructions, such as changing style, level of detail, or emphasis.

The server passes this new prompt to the generative AI model and obtains revised explanatory text. The server then selectively regenerates only the affected portions of the document while leaving other sections and layout unchanged. This selective regeneration reduces processing time, avoids unnecessary reformatting, and maintains consistency between updated narrative and existing numerical and visual content.

In a region-specific embodiment, the server identifies from the integrated data set a group of records belonging to a particular administrative region, and a group of records from private entity information associated with that region. The server computes region-specific evaluation indicators and generates region-specific visualizations, such as regional performance graphs. The server constructs prompt sentences that instruct the generative AI model to focus on the regional context and to interpret indicators in relation to local targets.

The server then generates and inserts region-tailored narratives into the document. This approach allows the system to reuse the same computational and template framework while generating technically distinct outputs for different regions, improving scalability and consistency across a large number of regional documents.

From a technical perspective, the described architecture improves the functioning of the computer system beyond simple automation of human drafting. By defining a common item schema and performing data integration at the server side, the system reduces redundant data transfers and conversions between applications. The use of vectorized operations and optimized numerical libraries on the integrated data set improves processing speed and reduces CPU usage compared to manual or naive implementations. The tight coupling between computed evaluation indicators, visualization data, structured prompts, and template fields ensures that changes in underlying data automatically propagate to narrative and visual outputs, reducing logical inconsistencies and human errors.

The use of a transformer-based generative AI model with structured prompt construction represents a non-conventional processing pattern in the context of document generation. Rather than generating free-form text and manually inserting it into documents, the server algorithmically derives prompt content from normalized data structures and evaluation indicators, thereby imposing machine-readable constraints on generation. This results in higher alignment between numerical content and narrative text and enables automated consistency checks. Furthermore, the feedback loop that reflects user edits into structured data and uses such data to reconstruct prompts and selectively regenerate document sections represents a specific control flow not present in conventional static document generators.

This loop reduces communication bandwidth by avoiding full document retransmission for minor changes, and increases system responsiveness by leveraging partial regeneration. Alternative embodiments may vary hardware or software components while preserving the core data flow. For example, the server may employ different relational or non-relational database technologies, different visualization libraries, or different word processing formats.

The generative AI model may be hosted externally or locally, and may use different neural architectures, such as encoder-decoder transformers or recurrent neural networks with attention. The terminal may be implemented as a native client application or as a browser-based interface. In all such variants, the server still integrates heterogeneous data into an integrated data set, computes evaluation indicators, generates visualization data, constructs structured prompts for a generative AI model, and composes the resulting explanatory text and visualizations into templates, while supporting user-driven refinement and selective regeneration.

In another embodiment, the server supports multiple template sets corresponding to different types of application documents or report documents. The server selects a particular template based on metadata in the integrated data set, such as program type or agency type. The server adjusts prompt sentences to reflect template-specific requirements, for example requesting additional sections or a different narrative order. In yet another embodiment, the server maintains separate generative models or different parameter profiles for different document types, allowing more specialized generation while reusing the same underlying data integration and evaluation computation components.

Through these configurations, the server, the terminal, and the interactions between them implement a concrete technical solution for transforming heterogeneous public and private data into integrated, consistent, and dynamically maintainable application and report documents. The system improves processing speed, accuracy, and data management within the computer, and provides a technical framework in which generative AI models operate under structured, data-driven control rather than as general-purpose text generators, thereby achieving a technical effect beyond mere automation of human drafting tasks.

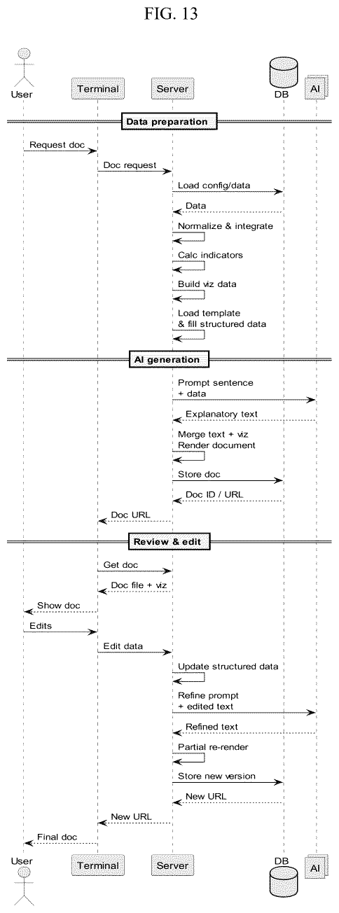

The following describes the processing flow using FIG. 13.

### Step 1:

The server acquires configuration information.

The server loads configuration files from a storage device, where the configuration files include database connection parameters, table mappings for public organization information and private entity information, and a common item schema definition. As input, the server receives file paths or identifiers of configuration files. The server parses the files into internal configuration objects, mapping source field names to normalized item names and data types. As output, the server produces an in-memory configuration structure that guides subsequent data acquisition and integration.

### Step 2:

The server connects to data storage apparatuses.

The server establishes network connections to one or more databases and storage services using the configuration information. As input, the server uses database host names, ports, user credentials, and storage endpoints. The server initiates secure sessions, creates connection pools, and verifies accessibility of target tables or objects. As output, the server holds active connections or client handles that can be used to retrieve public organization information and private entity information.

### Step 3:

The server retrieves public organization information and private entity information.

The server issues query statements or data retrieval requests over the established connections.

As input, the server uses query templates, target time periods, region identifiers, and project identifiers from the configuration. The server executes structured queries, receives result sets, and loads them into main memory as tabular data structures such as data frames. As output, the server produces separate in-memory tables for public organization information and private entity information, each with rows representing records and columns representing fields.

### Step 4:

The server normalizes and cleans the acquired data.

The server transforms the heterogeneous tables into a consistent format based on the common item schema. As input, the server uses the raw public organization table, the raw private entity table, and the schema mapping. The server applies column renaming, data type conversion (such as converting date strings to date-time objects and percentages to floating-point numbers), unit normalization (such as scaling all currency amounts to a base unit), and missing-value handling (such as filling or removing incomplete records). As output, the server generates normalized tables for public and private data, with aligned column names and data types.

### Step 5:

The server integrates public and private data into an integrated data set.

The server combines the normalized tables based on common key fields. As input, the server uses the normalized public organization table, the normalized private entity table, and key definitions such as region identifiers or project codes. The server performs join operations, matching rows that share the same key values and merging their attributes into unified rows.

The server may perform one-to-many or many-to-one joins depending on the relational structure. As output, the server produces an integrated data set with unified rows that contain both public and private attributes for each key.

### Step 6:

The server calculates evaluation indicators and evaluation criterion information.

The server performs numerical operations on the integrated data set to derive evaluation indicators. As input, the server uses the integrated data set and indicator definitions that specify formulas (for example, ratios and growth rates). The server computes aggregated values using grouping functions, then applies mathematical operations to create new derived columns, such as execution rates, beneficiary-per-unit-cost indices, and year-over-year growth values. As output, the server generates evaluation criterion information, including a set of indicator names, formulas, and computed values, stored as enriched columns in the integrated data set and as a separate structured indicator summary.

### Step 7:

The server prepares visualization data from the integrated data set and evaluation criterion information.

The server selects relevant subsets of data and aggregates them for graphical representation.

As input, the server uses the integrated data set, the evaluation criterion information, and visualization configuration specifying axes, grouping keys, and chart types. The server groups records by fiscal year, region, or category, computes sums, averages, or other aggregates, and then extracts lists of x-axis labels and γ-axis values. As output, the server produces visualization data structures containing arrays for chart inputs and tabular data for table outputs.

### Step 8:

The server generates tables and graphs as visualization outputs.

The server uses the visualization data to create human-readable figures. As input, the server uses x-axis arrays, y-axis arrays, labels, and table definitions produced in Step 7. The server calls plotting functions to render bar charts, line charts, or other graphs into image buffers, and formats tables into structured text or renderable table objects. The server encodes graph buffers into image files and stores them in temporary storage, and converts tables into formats suitable for embedding in documents. As output, the server produces graph image data and tabular data ready to be inserted into document templates.

### Step 9:

The server loads a document template and creates a structured data container for the template.

The server accesses a predefined document template corresponding to an application document or a report document. As input, the server uses a template identifier and retrieves the template file from a storage device. The server parses the template to detect placeholders for fields such as project title, budget summary, indicator sections, and figure captions. The server then creates an internal structured data container mapping template fields to data slots. As output, the server obtains a template object and an empty or partially populated structured data container.

### Step 10:

The server populates the structured data container with numerical data and visualization references.

The server maps elements of the integrated data set, evaluation criterion information, and visualization outputs to template fields. As input, the server uses the template field definitions, the integrated data set, the indicator summary, and the graph/table objects. The server selects representative values (for example, totals, key indicators, and highlighted metrics) and assigns them to scalar fields in the container. The server attaches references or paths to graph images and tables to designated figure and table fields. As output, the server produces a fully populated structured data container that matches the document template schema.

### Step 11:

The server constructs a prompt sentence for a generative AI model.

The server composes a textual instruction that encodes document requirements and summarizes key data. As input, the server uses the structured data container, indicator definitions, and document type metadata. The server extracts key values (such as total budget, execution rate, and main objectives), formats them as sentences or bullet-like inline text, and combines them with style instructions (such as “formal,” “for government use,” or “clear and concise”). For example, the server may create the following prompt sentence:

“Using the structured data for the 2023 fiscal year grant project, generate a formal application narrative. Describe the project background, objectives, implementation plan, budget details, and evaluation indicators. Align the content with standard public grant application requirements and reference the provided charts and tables where appropriate.” As output, the server produces a prompt sentence string ready for input to the generative AI model.

### Step 12:

The server invokes the generative AI model and obtains explanatory text.

The server sends the prompt sentence and, optionally, selected structured data to the generative AI model. As input, the server uses the prompt sentence, indicated parameters (such as maximum output length and temperature), and, in some cases, serialized data summaries. The server tokenizes the prompt, forwards token sequences to the generative AI model, and receives token probabilities in response. The generative AI model generates a token sequence representing narrative text, and the server decodes it into a character string. As output, the server obtains explanatory text that covers sections such as project background, objectives, implementation plan, and evaluation narrative.

### Step 13:

The server segments and assigns the explanatory text to template fields.

The server analyzes the generated explanatory text to identify logical section boundaries. As input, the server uses the raw explanatory text from Step 12 and section headings or patterns defined in configuration. The server splits the text into subtexts corresponding to sections such as background, goals, implementation, and evaluation. The server then assigns each subtext to a corresponding narrative field in the structured data container. As output, the server produces an updated structured data container that includes both numerical values and narrative text tagged by section.

### Step 14:

The server renders the document using the template and the structured data container.

The server applies the template engine to merge data into the template. As input, the server uses the template object and the populated structured data container. The server traverses template placeholders and replaces each placeholder with the corresponding scalar value, text segment, table markup, or embedded image reference. The server generates an intermediate or final document file in an editable format, such as a word processing file, and saves it to storage. As output, the server produces a machine-generated application document or report document that integrates numerical, visual, and narrative content.

### Step 15:

The server converts the rendered document into a distribution format and registers distribution information.

The server converts the editable document into a distribution format suitable for viewing and submission. As input, the server uses the rendered document file and format conversion settings. The server invokes a conversion tool to generate, for example, a portable document file, and stores both the editable and fixed-layout versions in an information storage apparatus. The server records metadata such as identifiers, version numbers, and file locations in a database. As output, the server produces distribution information, including links or identifiers that can be provided to a terminal.

### Step 16:

The terminal retrieves document metadata and files for display.

The terminal sends a request to the server for available documents associated with a user or a project. As input, the terminal uses user authentication information, project identifiers, and filters such as fiscal year. The terminal receives from the server a list of document metadata and distribution information. The terminal then requests specific document files and associated visualization images based on user selection. As output, the terminal obtains the document file bytes and visualization images for local display.

### Step 17:

The terminal displays the document content and accepts user edits.

The terminal renders the received document on a display device and overlays editing interfaces for designated editable sections. As input, the terminal uses the document file, visualization images, and metadata specifying editable fields. The terminal parses or interprets the document structure to locate editable sections and presents text input areas, selection controls, or annotation fields to the user. The terminal shows charts and tables alongside corresponding text sections. The terminal captures user modifications and additional content as the user types or selects. As output, the terminal accumulates modification information and additional information in a structured form.

### Step 18:

The user reviews and modifies the generated document content.

The user reads the narrative text, tables, and graphs displayed on the terminal. As input, the user uses the visual output from the terminal. The user identifies inaccuracies, missing context, or style issues and manually edits phrases, adds clarifications, or inserts additional sections. The user may also specify that certain sections should be simplified or elaborated. As output, the user generates revised text and annotations, which are captured by the terminal as modification information and additional information.

### Step 19:

The terminal sends modification information and additional information to the server.

The terminal transmits user edits back to the server. As input, the terminal uses the structured representation of modifications and additions, including identifiers for target sections and the new text. The terminal packages these items into a request payload and sends it over the network to a designated server endpoint. As output, the terminal delivers a message containing the modification information and additional information to the server.

### Step 20:

The server updates structured data and explanatory text based on user edits.

The server receives the modification information and additional information from the terminal. As input, the server uses the existing structured data container associated with the document and the user-provided edits. The server locates the affected fields, replaces or merges old content with new content, and updates internal representations of narrative and, if necessary, related indicators or tags. The server may perform validation or normalization on the user edits. As output, the server produces an updated structured data container reflecting both the original generated content and user modifications.

### Step 21:

The server optionally refines specific sections via the generative AI model.

The server decides whether to re-invoke the generative AI model for refinement based on user instructions or system settings. As input, the server uses the updated text for targeted sections and refinement instructions (for example, “simplify the wording” or “make more formal”). The server constructs a new prompt sentence such as:

“Rewrite the following evaluation section in a clear, formal style suitable for a government grant application. Keep all numerical values and indicators unchanged, but improve readability and coherence: [insert user-edited text here].”

The server passes this prompt sentence and the user-edited text to the generative AI model, receives refined text, and replaces the corresponding section in the structured data container. As output, the server obtains a refined version of the specific narrative sections.

### Step 22:

The server selectively regenerates affected parts of the document.

The server re-renders only the portions of the document that depend on updated structured data or refined explanatory text. As input, the server uses the updated structured data container, the template object, and information indicating which sections changed. The server instructs the template engine to update those sections without reprocessing unchanged parts.

The server then produces a new version of the document in the editable format and, if necessary, reconverts it to the distribution format. As output, the server yields an updated application document or report document that incorporates user edits and model refinements while preserving other content.

### Step 23:

The server stores the updated document and provides new distribution information.

The server saves the regenerated document files to the information storage apparatus and updates the document metadata. As input, the server uses the new editable and fixed-layout files and associated identifiers. The server writes the files to storage, assigns a new version number or timestamp, and updates database entries containing file locations and access information. The server returns updated distribution information or a notification to the terminal. As output, the server provides access paths for the user to obtain the revised final document.

### Step 24:

The terminal presents the final document to the user for use.

The terminal receives updated distribution information from the server and offers the user options to view, download, or transmit the final document. As input, the terminal uses the new access links or file identifiers. The terminal downloads and displays the final document or hands it off to a viewer or a printing function. As output, the terminal presents the finalized application or report document that integrates structured data, evaluation indicators, visualization data, and explanatory text generated and refined through the generative AI model and user interaction.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented reporting and application systems are typically designed as static pipelines: a processor acquires domain data, performs predetermined aggregation, and fills fixed templates to generate documents. Such systems exhibit multiple technical shortcomings. First, the data-processing logic is rigid and vertically siloed, requiring separate implementations for different data sources such as open government datasets, private commercial datasets, sensor streams from production environments, and transaction records from financial systems. As a result, the processor must execute redundant data-acquisition, transformation, and formatting routines, which increases processing overhead and complicates maintenance. Second, document-generation components are generally rule-based and do not flexibly adapt the content or level of detail to changing data distributions or usage contexts, which forces the processor to apply additional post-processing and manual correction by a human operator.

Further, conventional systems do not exploit generative AI models as first-class components within a data-processing pipeline. Even where a generative AI model is used, it is typically invoked with ad hoc prompt text that is manually authored, without systematic use of structured intermediate results (such as computed indicators, aggregated time-series, and visualization outputs). This results in inconsistent output quality and forces the processor to implement additional validation and rewriting steps. Moreover, known systems lack a unified mechanism for participating components to dynamically adjust prompt content or target indicators in response to user-related signals.

In particular, conventional architectures treat user emotion as a user-interface concern, separate from core computation. The processor does not receive emotion information or sentiment-analysis results as part of the computational state, and therefore cannot modify internal parameters such as evaluation indicators, target values, or template selection based on emotion. This separation prevents the processor from performing adaptive control of the generative AI model and formatting logic, so that document generation remains static even when telemetry shows that a user is stressed, anxious, or highly satisfied. This leads to inefficient use of computational resources, because the processor repeatedly generates verbose or overly complex documents that users do not actually need, and requires additional user interactions to obtain simplified outputs.

In addition, conventional systems that produce reports for production processes or financial guidance often run on separate stacks. A processor dedicated to manufacturing analytics receives time-series measurement information from detection devices, while another processor dedicated to financial analysis receives transaction information such as expenditure records. These systems rarely share a common abstraction for integrating public information and non-public information, computing evaluation indicators, performing aggregation and visualization, and invoking generative AI models with structured prompts. Consequently, the overall computing environment is fragmented: multiple heterogeneous processors must maintain independent data models, visualization pipelines, and document-generation code, which increases latency, memory footprint, and susceptibility to inconsistency among generated outputs.

Therefore, there is a need for a computer-centric solution that technically improves the way a processor integrates heterogeneous datasets, computes and manages evaluation indicators, and orchestrates interaction with a generative AI model. Such a solution should allow the processor to construct prompt sentences systematically from structured intermediate results, to adapt the prompt content and formatting logic dynamically in response to emotion information, and to deliver unified processing for different use cases such as production-status reporting and expenditure-advice generation. By embedding these functions into the processor's configuration, the invention seeks to improve the efficiency, adaptability, and consistency of computer-implemented document generation, rather than merely automating human drafting work.

The specific processing by the specific processing unit 290 of the data processing device 12 in Application Example 2 is realized by the following means.

The present invention provides a server comprising a processor configured to acquire and integrate public information and non-public information into unified numerical datasets, to calculate evaluation indicators from the integrated datasets, to further acquire time-series measurement information and transaction information and perform aggregation and visualization in association with the evaluation indicators, to operate a generative AI model using, as input, structured information including results of the aggregation and visualization together with a prompt sentence comprising a natural-language instruction, to automatically generate document data for reports or applications based on an output of the generative AI model, to create an electronic document including both the document data and the visualization results in accordance with predetermined formatting information, to acquire emotion information or emotion estimation results related to a user and modify at least one of the prompt sentence, the evaluation indicators, and the formatting information in accordance with the emotion information so as to dynamically adjust an output content or a target value of the generative AI model, and to convert the electronic document into an output format deliverable to a terminal device. This enables the processor to implement a technically improved, adaptive document-generation pipeline that unifies heterogeneous data sources, systematically constructs and refines prompts for a generative AI model from structured intermediate results, and dynamically controls both model behavior and formatting in response to emotion information, thereby reducing redundant computation, lowering the need for manual post-editing, and improving consistency, responsiveness, and resource efficiency of computer-implemented reporting and advisory services.

The term “public information” refers to data that is made available by a public entity such as a government or public organization, including but not limited to statistical data, budget data, infrastructure data, crime data, and other datasets that are accessible without confidential access controls.

The term “non-public information” refers to data that is held by a private entity or individual and is not generally available to the public, including but not limited to commercial data, market-research data, internal operational data, and personally related transaction data.

The term “evaluation indicators” refers to numerical or categorical values computed from one or more datasets and used to measure, compare, or monitor performance, status, or progress of a process, project, region, or entity, such as key performance indicators, target values, or composite indices.

The term “time-series measurement information” refers to data that represents measurements acquired over time from one or more sensing devices, including but not limited to sensor outputs indicating operation states, production counts, defect counts, or environmental conditions, each associated with a timestamp or time interval.

The term “transaction information” refers to data representing discrete events of value exchange or resource usage, including but not limited to expenditure records, budget allocations, financial transfers, purchases, or other economic activities associated with an entity and a time.

The term “aggregation” refers to a data-processing operation in which multiple records are combined according to one or more grouping keys to compute summary values such as sums, counts, averages, maxima, minima, or ratios.

The term “visualization” refers to the generation of graphical or tabular representations of data, including but not limited to charts, graphs, maps, and tables, which allow a user or a process to perceive patterns, trends, or distributions in the underlying data.

The term “structured information” refers to information organized according to a defined schema or format, such as tables, key-value pairs, or hierarchical data structures, in which the semantics of each element are machine-interpretable and can be programmatically accessed by a processor.

The term “prompt sentence” refers to one or more natural-language expressions that instruct a generative AI model regarding a desired output, and that may include explicit task descriptions, constraints, data summaries, or references to additional structured information.

The term “generative AI model” refers to a machine-implemented model, such as a neural-network-based model trained on large datasets, that receives input including a prompt sentence and optionally structured data, and produces newly generated output data such as natural-language text, code, or other content not predetermined by simple retrieval.

The term “document data” refers to data that represents textual or structured content intended to be included in a document, such as paragraphs, headings, lists, tables, or metadata, and that can be formatted and combined with other elements to form an electronic document.

The term “electronic document” refers to a machine-readable representation of a document, including but not limited to files or data objects in formats such as text, markup, word-processing formats, or page-description formats, which can contain document data, visualization results, and layout information.

The term “formatting information” refers to data defining how content is arranged and presented in an electronic document, including but not limited to templates, styles, layout rules, placeholder specifications, and mappings between data fields and document regions.

The term “emotion information” refers to data indicating an emotional state or attitude of a user, obtained directly from user input or indirectly through analysis of user behavior or signals, and including but not limited to labels such as stress, anxiety, satisfaction, or joy, and associated intensity values.

The term “emotion estimation results” refers to output produced by an emotion-recognition or sentiment-analysis process that infers a user's emotional state from input data such as text, voice, or images, and that may include one or more emotion categories and corresponding scores.

The term “output content” refers to information produced by the generative AI model or by downstream formatting processes, including but not limited to generated natural-language text, selected data fields, and arrangement of document sections that will be delivered to a user.

The term “target value” refers to a value used as an objective, threshold, or goal for an evaluation indicator, such as a desired productivity level, consumption growth percentage, or budget utilization rate, against which actual performance can be compared.

The term “terminal device” refers to an end-user computing apparatus that communicates with the server, including but not limited to a personal computer, a tablet, a smartphone, or another network-connected device capable of presenting electronic documents.

The term “production process” refers to a series of operations or stages in which raw materials, components, or intermediate products are transformed into finished products, and which may be monitored by detection devices providing time-series measurement information.

The term “operation state information” refers to time-dependent data describing the status of equipment or resources in a process, including but not limited to on/off states, error conditions, production rates, and downtime intervals.

The term “productivity indicators” refers to evaluation indicators that quantify the efficiency or output of a production process, such as produced units per time, defect rates, utilization rates, or throughput measures.

The term “expenditure information” refers to transaction information representing outflows of resources, such as payments or costs incurred by a public organization or an individual, categorized by purpose, time period, or other attributes.

The term “spending tendencies” refers to patterns or trends derived from expenditure information over one or more periods, including distributions of spending across categories, temporal changes, and relative increases or decreases.

The term “analysis results” refers to data produced by processing raw or aggregated information, including but not limited to computed statistics, identified patterns, classifications, and derived suggestions such as saving proposals.

The term “saving proposals” refers to recommendations derived from analysis results, specifying one or more ways to reduce or optimize expenditures while maintaining desired outcomes.

The term “concrete action plan” refers to a structured set of one or more explicitly described steps or measures that a user can take to influence an evaluation indicator or financial situation, including associated conditions, priorities, or time frames.

In one embodiment, a server includes at least one processor, a main memory, a non-volatile storage device, and a network interface coupled via a system bus. The server executes an operating system such as a general-purpose server operating system and middleware including a web server, an application server, and a database management system. The server communicates with one or more terminal devices operated by users via a wired or wireless network. Each terminal includes a processor, a memory, a display, an input device, and optionally a camera and a microphone.

The server stores program modules in the non-volatile storage device. The program modules include a data acquisition module, a data integration module using a tabular-data processing library, an indicator computation module, a time-series aggregation and visualization module, a prompt construction module, a generative AI interface module, a document assembly module, an emotion analysis and control module, and an output delivery module. The server also stores configuration data such as data-source definitions, template definitions, and model-control parameters.

The server uses a database server, such as a relational database management system, to store public information and non-public information. Public information includes structured records obtained from public-sector open data APIs. Non-public information includes tabular or time-series records obtained from private-sector data feeds, internal business databases, manufacturing sensors, and transaction systems. The server represents all such information internally as columnar tables, for example as data frames managed by a data-analysis library such as a table-oriented numerical library.

The server uses a numerical computation library and a scientific computation library to compute evaluation indicators from the integrated datasets. The server uses a plotting library or a spreadsheet application interface to generate visualization results such as line charts, bar charts, and tables. The server uses a document-generation library and a page-description converter to assemble electronic documents.

The server uses a generative AI model deployed as a separate inference service accessible over a network. The generative AI model is, for example, a transformer-based neural network including an embedding layer, multiple self-attention blocks, and a language modeling head.

The generative AI model is pre-trained on a large corpus of natural-language data and optionally fine-tuned on domain-specific corpora such as technical reports, applications, and financial advisories. The model uses a learned token embedding matrix, multi-head attention weights, feedforward layer weights, and layer-normalization parameters. The server does not modify these weights at inference time but controls the model's behavior by controlling the prompt sentence, the additional structured context, and decoding parameters such as temperature and maximum output length.

The server maintains an internal data structure for each task instance. The data structure includes pointers to raw tables (for example, public data tables, private data tables, manufacturing sensor tables, transaction tables), integrated tables, indicator tables, visualization metadata, prompt templates, emotion state vectors, and generated document fragments. The server uses this structure to ensure that all modules access consistent intermediate results and to avoid re-computation.

In a typical configuration, the server acquires public information and non-public information via the data acquisition module. The server uses an HTTP client library to send requests to public data endpoints and private data endpoints and receives responses in a structured format such as a hierarchical text format. The server parses each response into a row-oriented intermediate representation and then converts the representation into a tabular representation managed by the data-analysis library. The server stores the tabular data in the relational database and caches frequently accessed subsets in memory.

The server performs integration of public information and non-public information by joining tables on shared keys such as geographic codes, time periods, or entity identifiers. The server uses optimized join operations offered by the table-oriented numerical library, which internally implement vectorized operations over contiguous memory. This reduces memory fragmentation and improves cache locality compared to naive row-by-row processing. The server produces an integrated data frame in which each row represents a combined record including public attributes (for example, population, budget, infrastructure metrics) and non-public attributes (for example, consumption values, production quantities, expenditure items).

The server computes evaluation indicators by applying column-wise and group-wise functions to the integrated data frame. For each indicator, the server records the formula, such as weighted sums, ratios, moving averages, or regression-based scores. The server uses vectorized operations and, where necessary, a linear-algebra library to compute the indicators. This design improves computational efficiency by reducing the number of interpretation steps and by using optimized numerical kernels. Examples of evaluation indicators include: a productivity indicator computed as produced units per operation hour; a defect-rate indicator computed as defective units divided by produced units; a consumption growth indicator computed as a percentage increase over a baseline; and composite indicators computed as linear or non-linear combinations of base metrics.

The server acquires time-series measurement information from detection devices installed in a production process. Detection devices include sensors attached to production equipment, programmable logic controllers, and monitoring gateways. Detection devices transmit operation state information, such as run/idle/fault states, piece counts, and timestamps, to the server via an IoT message broker. The server subscribes to specific topics and receives measurement messages. The server parses each message and writes the data into a time-series table. The server ensures that timestamps are normalized to a consistent time zone and that out-of-order messages are ordered using a primary key index.

The server aggregates time-series measurement information using resampling, grouping, and windowing operations. The server divides continuous time into fixed intervals (for example, hourly or per shift) and aggregates measurements within each interval. This includes summing produced units, counting defects, calculating utilization as a fraction of time in a run state, and computing rolling averages of key metrics. The server uses sliding windows and cumulative calculations to detect sustained trends and anomalies. Due to the use of specialized time-series indexing in the data-analysis library, these operations are executed using time-indexed vectorized loops, reducing computational cost compared to naive iteration.

The server generates visualization results by feeding aggregated indicator tables to a plotting engine or a spreadsheet interface. For example, the server generates a time-series plot of productivity indicators by mapping the time index to the horizontal axis and the metric value to the vertical axis. The server uses consistent color and style mapping to enable the generative AI model to refer to graphs in a reproducible manner. The server records the file names, chart types, and axis descriptions as visualization metadata. The server stores visualization results in an object store and registers their locations in the task data structure.

In a manufacturing use case, the server uses, as the time-series measurement information, operation state information acquired from detection devices installed in a production line.

The server computes productivity indicators per line and per shift and stores these indicators in a table. The server then passes the indicators and the visualization metadata to the prompt construction module.

The server constructs a prompt sentence for the generative AI model by combining a template and instance-specific values. The template is stored as a text pattern with placeholders for indicator values, time ranges, and references to graphs. The server substitutes computed values into the placeholders. For example, the server may construct a prompt sentence such as:

“Using the following key performance indicators for Production Line A on 2023 Apr. 1 (operating time: 15 hours, total produced units: 12,000, defect rate: 1.8%), please generate a concise report describing the operating status, highlight any anomalies, and reference the corresponding charts that show hourly throughput and defect rate trends.” The server may generate additional prompt text listing short descriptions of each visualization, such as “FIG. 1: hourly production; FIG. 2: hourly defect rate.” The server may also include a compact tabular summary encoded as natural-language sentences, so the generative AI model receives both human-readable and machine-interpretable context.

In a financial-advice use case, the server uses, as the transaction information, expenditure information of a public organization or an individual. The server aggregates past-period spending tendencies by grouping expenditures by category and month and computing totals and relative changes. The server identifies categories with significant increases or decreases by applying threshold-based rules or rank-based selection. The server then constructs a prompt sentence incorporating these analysis results. For example, the server may construct a prompt sentence such as:

“Using the user's spending data for the last 3 months, summarized as follows: total monthly food expenses: 40,000 (up 20% from last month), entertainment: 15,000 (stable), utilities: 10,000 (down 5%), please analyze this month's spending tendencies and generate savings suggestions. The user reports: ‘I feel my food expenses are too high and I am anxious.’ Please provide empathetic and practical advice.”

The server attaches the analysis results as human-readable text generated from the aggregated tables. Because the server uses a consistent structured description of the analysis, the generative AI model can learn to map recurring patterns of summary text to reliable output structures, improving the stability of generated documents.

The server interfaces with the generative AI model via an inference API. The generative AI interface module encodes the prompt sentence into tokens using the same tokenizer as the generative AI model. The module sets decoding parameters such as temperature, nucleus sampling probability, and maximum token count according to the document type, so that technical reports may use lower randomness and advice documents may use higher variety.

The server sends the encoded prompt to the model and receives a sequence of tokens representing the model's output. The server then decodes the tokens into natural-language text.

The server does not simply forward arbitrary user-supplied prompts; instead, the server uses a fixed set of rule-based transformations to combine structured analysis results and emotion information into a canonical prompt structure. This non-conventional use of prompts causes the generative AI model to act as a controlled transformation function over structured computation outputs, rather than a generic text generator. As a result, the system improves consistency and reduces the risk of hallucinated or irrelevant content, which directly improves computational accuracy and reduces the need for post-generation filtering and correction.

The server receives emotion information or emotion estimation results from the emotion analysis and control module. Emotion information may originate from the terminal or from an external analysis service. In one embodiment, the terminal captures user text inputs and sends them to the server. The server calls a sentiment-analysis service that uses a neural-network classifier trained on labeled sentiment data. The classifier is, for example, a bidirectional recurrent neural network or a transformer-based classifier with a softmax output layer. The classifier outputs probabilities for emotion categories such as anxiety, satisfaction, stress, and neutrality. The server converts these probabilities into an emotion vector and stores it as part of the task data structure.

In another embodiment, the terminal uses its camera and microphone to capture the user's facial expressions and voice. The terminal runs a convolutional neural network on video frames to extract facial features and a recurrent or transformer-based network on audio features such as pitch, energy, and spectral characteristics. The terminal classifies the user's emotion state and sends the classification label and confidence scores to the server. The server treats these as emotion estimation results.

The server uses emotion information to modify the prompt sentence, evaluation indicators, and formatting information before sending the input to the generative AI model. For example, if the emotion vector indicates stress or anxiety, the server may choose a simplified prompt pattern that explicitly instructs the model to produce short, clear explanations and to avoid unnecessary technical language. The server may reduce the maximum token count and force bullet-point output by including explicit instructions in the prompt such as “Use bullet points and short sentences.” Conversely, if the emotion vector indicates satisfaction and stability, the server may instruct the model to propose more ambitious targets by adjusting evaluation indicators upward, such as multiplying specific target values by a factor greater than one. The server also may switch between different templates that control which sections appear in the final document, adding an “Action Plan” section when anxiety is detected.

The server's control logic implements these modifications using deterministic rules mapped from emotion vectors to configuration changes. For example, a rule table may specify that when the anxiety score exceeds a threshold, the system applies a particular prompt template, reduces complexity settings, and enables an additional explanatory section. These rule-based transformations differ from traditional manual editing, because they rely on machine-read emotion vectors and automatically modify both model-control parameters and document formatting, improving technical behavior inside the computing pipeline.

The server assembles an electronic document by combining the generative AI output with visualizations and static template components. The document assembly module reads a template definition that describes page layout, section order, font styles, and placeholder mappings. The module replaces placeholders with generated paragraphs, tables of computed indicators, and links or embedded images for graphs. The module integrates all parts into a single electronic document in a word-processing format and then converts the document into a page-description format using a converter. The server optimizes this process by reusing templates and caching partial documents for similar tasks.

The server then converts the electronic document into an output format deliverable to a terminal device. The output delivery module may provide the document as a downloadable file, as an email attachment, or as a rendered view in a web browser. The server sends only compressed, final documents rather than full intermediate data frames or raw sensor data, thereby reducing network bandwidth consumption. This contributes to a technical improvement in communication efficiency, especially when terminal devices operate over constrained networks.

The terminal receives documents and displays them to the user. The terminal may render the document in a browser or a dedicated viewer. The terminal may also provide interactive controls allowing the user to request regeneration under different conditions or to submit feedback. Feedback text is transmitted back to the server and can be used to update emotion information or to adjust future prompts.

This architecture yields several technical advantages. By representing integrated datasets as columnar tables processed with vectorized numerical routines, the server reduces CPU cycles and memory allocations compared to naive, record-oriented implementations. By consolidating public information, non-public information, time-series measurement information, and transaction information into a unified processing pipeline, the server avoids redundant parsing and conversion layers that would otherwise exist across separate systems. By treating the generative AI model as a controlled component driven by structured prompt construction, the server improves determinism and reliability of generated outputs compared to arbitrary free-form usage. The server's rule-based mapping from emotion vectors to prompt templates and indicator adjustments allows dynamic adaptation without retraining the generative AI model, which contributes to responsiveness while keeping model-inference computation constant.

Moreover, by coupling emotion-aware control with the document-generation pipeline, the system allows the processor to generate documents that match a user's cognitive load and informational needs without manual reconfiguration. This reduces the number of user interactions required to obtain usable output, which in turn reduces the number of requests sent to the generative AI service and reduces overall system latency.

In the manufacturing scenario, the server directly influences control-relevant information flows: by providing precise, automatically generated reports based on high-frequency sensor data and refined indicators, the system allows downstream control components or human operators to adjust machine schedules or maintenance operations in a timely manner. In the financial scenario, the server provides timely and consistent analysis of large transaction datasets that would not be tractable for a human to process manually in comparable time. In both cases, the improvements stem from specific computer-implemented processing techniques: optimized data structures, rule-based emotion-aware prompt control, and dynamic formatting logic, rather than from mere automation of human drafting tasks. Various modifications and alternatives can be implemented. For example, the generative AI model may be replaced by a different sequence-to-sequence architecture or a mixture-of-experts model, while preserving the structured prompt construction and emotion-based control concepts. The emotion classifier may be located entirely on the server or entirely on the terminal, or divided between them. The integration of public and non-public information may use different storage technologies, such as column-oriented databases or distributed key-value stores, as long as integrated tables and evaluation indicators are computed. The aggregation window sizes, indicator formulas, and rule tables mapping emotion vectors to configuration changes can be tailored to different domains.

In all such embodiments, the server, the terminal, and the user cooperate through the described hardware and software configuration to realize a system in which a processor acquires and integrates diverse data, computes evaluation indicators, aggregates and visualizes measurement and transaction information, constructs controlled prompt sentences, invokes a generative AI model, and dynamically adjusts output content and target values based on emotion information, thereby providing a concrete improvement to computer-implemented data processing and document generation.

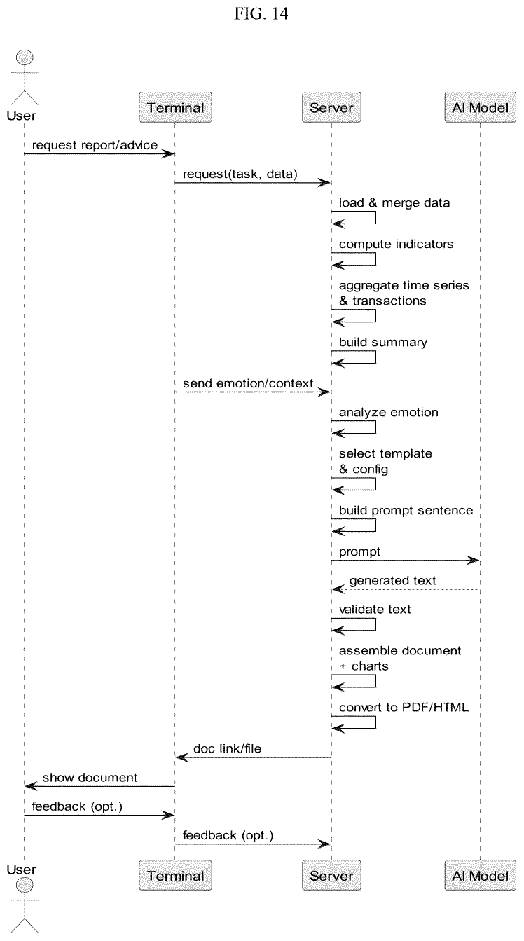

The following describes the processing flow using FIG. 14.

### Step 1:

Server acquires source data.

Server receives public information and non-public information as input from external data sources via a network interface. Server sends HTTP or database requests, parses responses in a structured format, and converts records into internal tabular structures. Server outputs normalized tables in a database and cached data frames in memory as the basis for further processing.

### Step 2:

Server integrates heterogeneous datasets.

Server takes, as input, multiple normalized tables representing public information (for example, population and budget data) and non-public information (for example, consumption, production, or expenditure data). Server performs join operations on shared keys such as region codes, entity identifiers, or time periods, and resolves type differences and missing values. Server outputs an integrated data frame in which each row combines attributes from all relevant sources.

### Step 3:

Server computes evaluation indicators.

Server uses the integrated data frame as input and applies vectorized numerical operations to compute evaluation indicators, such as productivity, defect rate, consumption growth, or composite indices. Server groups data by specified dimensions (for example, region, time, or line ID) and executes aggregation functions (sum, average, ratio, regression-based score).

Server outputs an indicator table that stores each computed indicator together with its keys and metadata.

### Step 4:

Server acquires and aggregates time-series measurement information.

Server receives, as input, time-stamped operation state information from detection devices in a production process via an IoT or message-queue interface. Server writes each message into a time-series table and then resamples and aggregates records by fixed intervals (for example, hourly or per shift) to calculate total produced units, total running time, downtime, and rolling averages. Server outputs an aggregated time-series table indexed by time and equipment identifier.

### Step 5:

Server acquires and aggregates transaction information.

Server takes, as input, transaction records such as expenditure entries from public organizations or individuals, received from financial systems or uploaded files. Server classifies each record into categories, normalizes timestamps, and groups records by category and period. Server calculates totals, averages, and percentage changes for each category.

Server outputs a transaction-analysis table that captures spending tendencies over one or more periods.

### Step 6:

Server generates visualization results.

Server uses the indicator table, the aggregated time-series table, and the transaction-analysis table as input to a visualization module. Server maps selected fields to axes and series, generates charts such as line graphs for time evolution and bar charts for category distributions, and generates summary tables. Server outputs visualization files (for example, images or embedded charts) and visualization metadata describing chart types, axes, legends, and storage locations.

### Step 7:

Terminal captures user context and emotion information.

Terminal receives user inputs such as free-text comments or voice and image data as input.

Terminal optionally runs local models to estimate user emotion from voice tone and facial expressions or transmits raw or preprocessed signals to the server. Terminal outputs emotion labels and confidence scores, or raw text expressing user feelings, and sends this data to the server as part of a context payload.

### Step 8:

Server derives emotion information and emotion estimation results.

Server takes, as input, user text, audio, or emotion labels from the terminal. Server invokes an emotion recognition or sentiment-analysis function, which applies a trained classifier to generate probabilities for emotion categories such as anxiety, satisfaction, or stress. Server converts classifier outputs into an emotion vector with category scores and stores the result.

Server outputs emotion information and emotion estimation results to be used for adaptive control of later processing.

### Step 9:

Server selects templates and configuration based on task and emotion.

Server receives, as input, a task specification from the terminal (for example, “generate production report” or “generate spending advice”) and the current emotion vector. Server consults a rule set that maps task types and emotion conditions to document templates, indicator sets, visualization bundles, and model-control parameters. Server selects an appropriate template, selects which indicators and charts to include, and adjusts settings such as document length and level of detail. Server outputs a configuration object describing the selected template, included data, and generative AI settings.

### Step 10:

Server constructs a structured summary from analytical results.

Server takes, as input, the indicator table, aggregated time-series table, transaction-analysis table, and the configuration object. Server formats key metrics and trends into structured natural-language fragments, such as sentences summarizing operating time, production counts, defect rates, or spending changes. Server orders these fragments according to importance and task type. Server outputs a structured summary text and an ordered list of data items that will be referenced in the prompt sentence.

### Step 11:

Server constructs a prompt sentence for the generative AI model.

Server receives the structured summary text, emotion information, and the configuration object as input. Server applies a prompt template, inserting indicator values, descriptions of visualizations, and explicit instructions regarding style, length, and tone informed by emotion (for example, simplified instructions under stress, more detailed planning under satisfaction).

Server may generate, for example, the following prompt sentence for a production report: “Using the following key performance indicators for Production Line A on 2023 Apr. 1 (operating time: 15 hours, total produced units: 12,000, defect rate: 1.8%), please generate a concise report describing the operating status, highlight any anomalies, and reference the corresponding charts that show hourly throughput and defect rate trends.” Server or a different template may generate, for a spending-advice task:

“Using the user's spending data for the last 3 months, summarized as follows: total monthly food expenses: 40,000 (up 20% from last month), entertainment: 15,000 (stable), utilities: 10,000 (down 5%), please analyze this month's spending tendencies and generate savings suggestions. The user reports: ‘I feel my food expenses are too high and I am anxious.’ Please provide empathetic and practical advice.”

Server outputs the final prompt sentence and associated structured context ready for submission to the generative AI model.

### Step 12:

Server invokes the generative AI model with controlled inputs.

Server uses the prompt sentence and structured context as input to the generative AI interface module. Server encodes the prompt using a tokenizer compatible with the generative AI model and sets decoding parameters as specified by the configuration object (for example, temperature, maximum tokens, and sampling strategy). Server sends the encoded prompt and parameters to the generative AI model running on an inference engine and receives a sequence of tokens representing generated output. Server decodes the tokens to recover natural-language text. Server outputs generated document data, such as report text, justification text, or advice paragraphs.

### Step 13:

Server validates and post-processes generated document data.

Server takes the generated document data and the structured summary as input. Server checks for required sections, consistency of key numerical values, and adherence to basic constraints (for example, no empty sections, presence of requested headings). Server may correct simple formatting issues or re-request generation if constraints are violated. Server outputs cleaned and validated document data ready for assembly into an electronic document.

### Step 14:

Server assembles an electronic document with visualizations.

Server receives validated document data, visualization files, and template definitions as input.

Server applies the template to determine section layout, heading styles, and placeholder locations. Server inserts generated text into designated sections, embeds tables constructed from indicator tables, and attaches or embeds visualization images or chart objects referenced in the prompt. Server constructs a complete electronic document file in a word-processing or markup format. Server outputs the assembled electronic document as an intermediate representation.

### Step 15:

Server converts the electronic document into a terminal-deliverable format.

Server takes the intermediate electronic document as input and invokes a conversion component to generate a page-description or other delivery format (for example, a portable document format or web-renderable markup). Server may compress the output and strip unnecessary metadata to reduce file size. Server outputs a final document file and a delivery descriptor containing links or identifiers suitable for retrieval by the terminal.

### Step 16:

Terminal retrieves and presents the generated document.

Terminal receives, as input, document identifiers or links from the server via an application interface. Terminal issues a request to download the final document file and stores it temporarily or permanently in local storage. Terminal renders the document on a display using a viewer or browser, allowing zoom, scrolling, and navigation between sections.

Terminal outputs visual and, if appropriate, audio representations to the user.

### Step 17:

User reviews the document and provides feedback or new requests.

User reads the displayed report, application, or advice document as input and may identify sections requiring clarification, correction, or additional detail. User enters feedback text, selects options (for example, “simplify,” “add more technical details,” or “change target values”), or initiates a new generation request via the terminal interface. User's inputs are transmitted by the terminal to the server as a new context, which becomes input for subsequent executions of Steps 7 through 15, enabling iterative refinement and continuous improvement of generated outputs.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

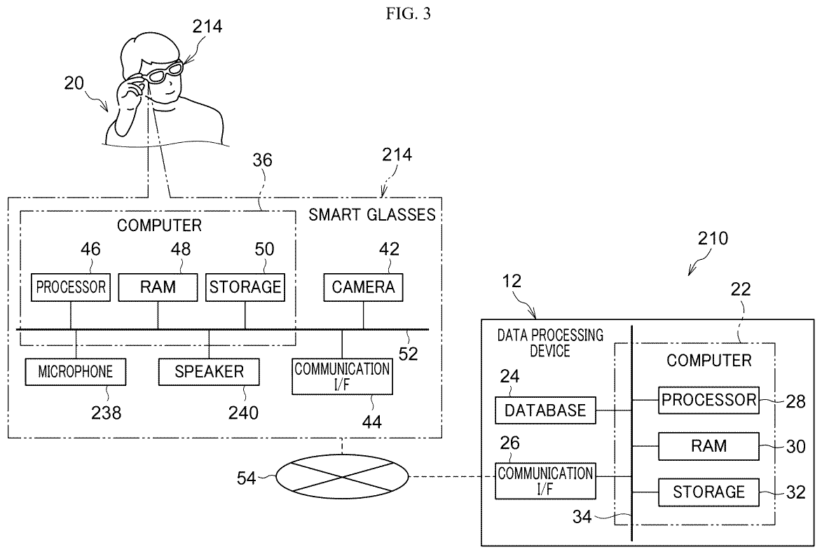

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

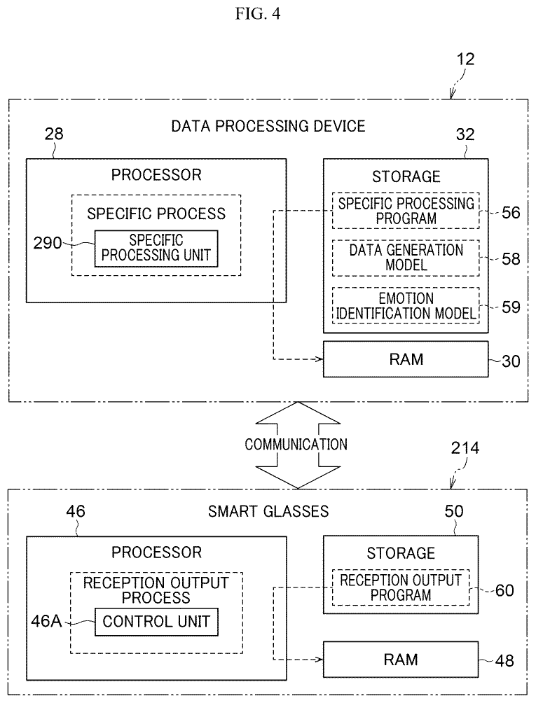

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

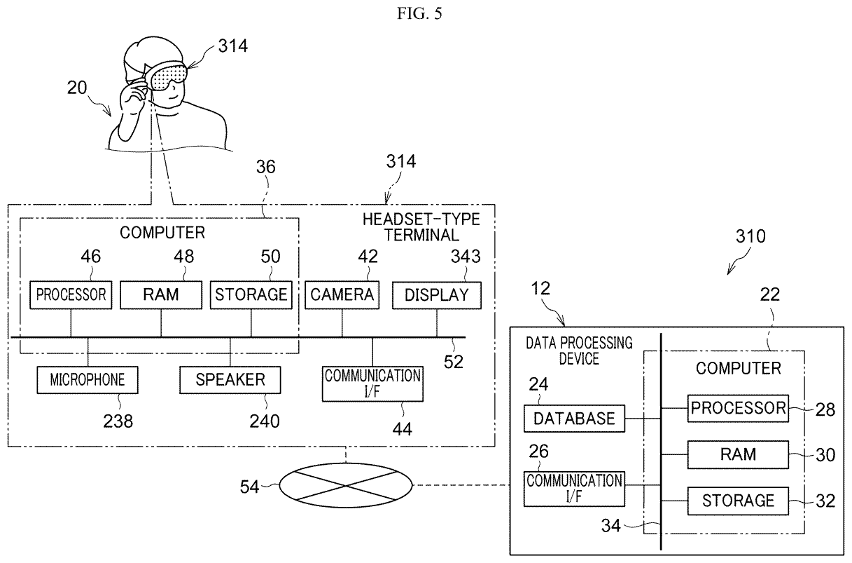

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

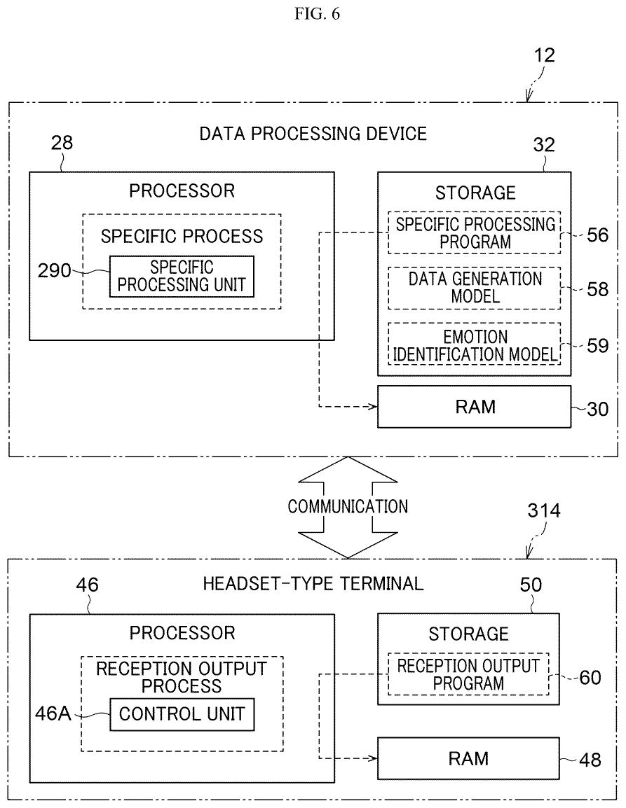

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

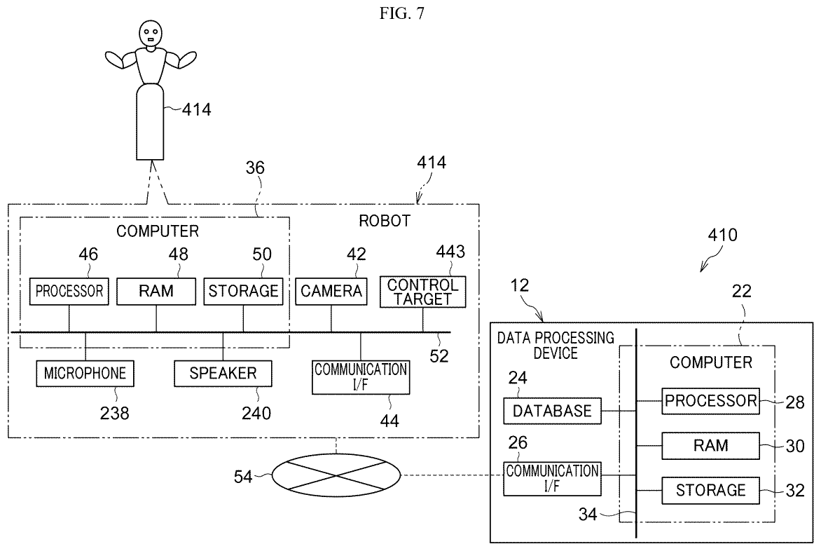

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

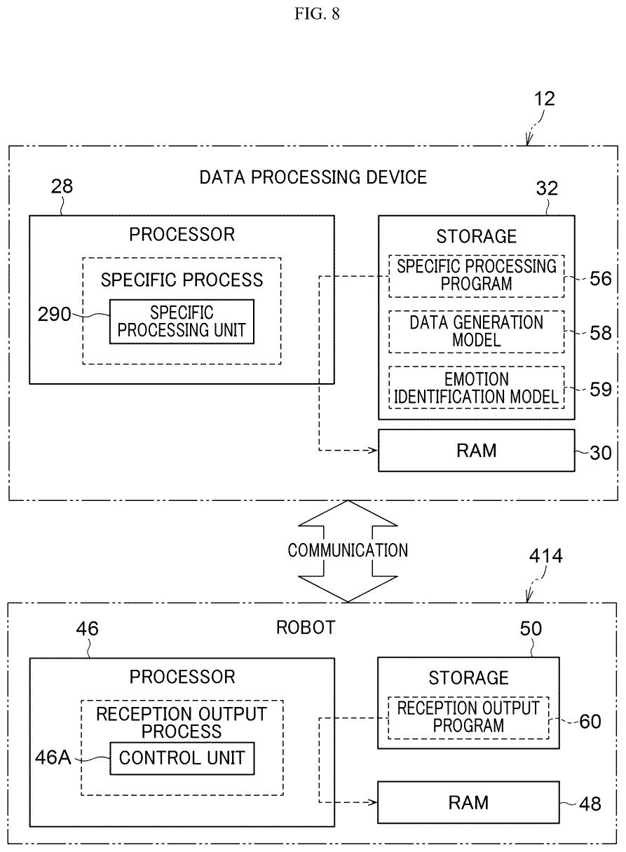

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

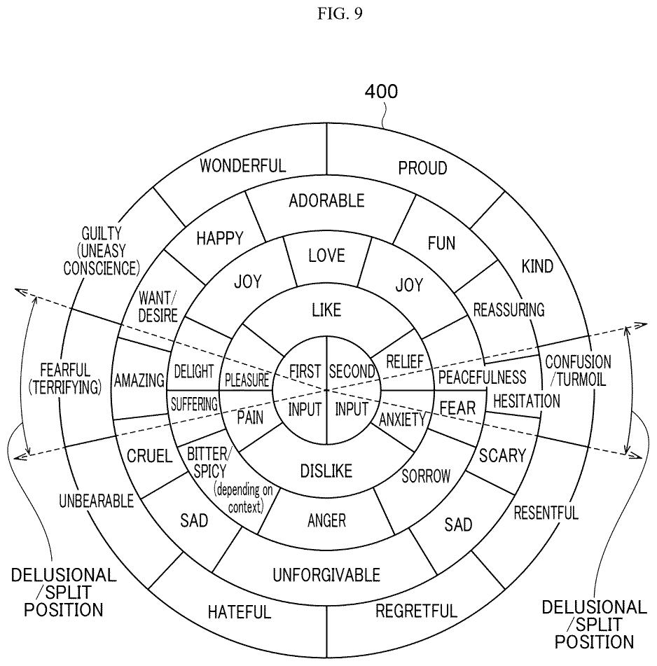

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

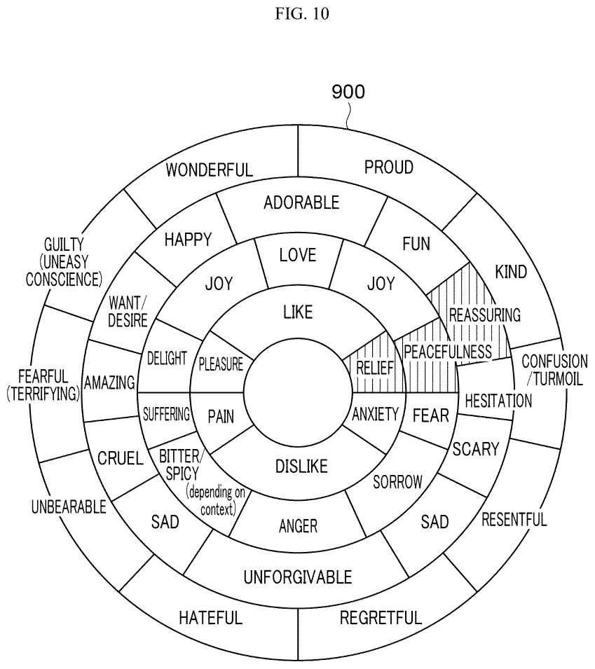

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire structured information provided by a public entity and structured information provided by a non-public entity, and generate an integrated information set by normalizing formats and identifiers of the structured information and associating the structured information with each other, and
set, on an information storage device that stores the integrated information set, an information structure including attribute types, constraint conditions, and association relationships, and record the integrated information set in accordance with the information structure while maintaining consistency of the integrated information set, and
obtain the integrated information set and generate indicator information including change rates of quantitative information, ratios of quantitative information, and resource allocation amounts per unit quantity by performing a calculation, and set evaluation criteria relating to social capital development based on the indicator information, and
generate analysis results including an information summary and a resource allocation plan over a plurality of periods based on the evaluation criteria and the indicator information, and record the analysis results as structured information, and
generate an input information set including a prompt sentence input by a user, the evaluation criteria, and the analysis results, and configure the input information set as an input to a generative AI model, and
transmit, to the generative AI model, the input information set including the prompt sentence, and obtain, from the generative AI model, response information including draft information of application documents, report documents, and supplementary materials over a plurality of years, and
automatically generate tabular information and graphical information conforming to a predetermined format based on the response information and the indicator information, and automatically create report documentation in which the tabular information and the graphical information are incorporated into the draft information.

### (Supplementary 2)

The system according to supplementary 1,
wherein the processor is configured to
identify, from the integrated information set, a combination of the structured information of the public entity associated with a specific geographic area and the structured information of the non-public entity associated with the specific geographic area, and generate indicator information and evaluation criteria specific to the specific geographic area based on the combination, and create a resource allocation plan and report documentation specific to the specific geographic area.

### (Supplementary 3)

The system according to supplementary 1,
wherein the processor is configured to store format definition information of the report documentation, generate a document structure in which the draft information, the tabular information, and the graphical information are arranged based on the format definition information, add an adjustment condition corresponding to attribute information or reaction information of the user to the prompt sentence to modify the input information set for the generative AI model, and adjust contents and expressions of the response information obtained from the generative AI model.

### Application Example 1

### (Supplementary 1)

A system comprising a processor,
wherein the processor is configured to
acquire multiple types of public information and multiple types of private information via a communication network, perform preprocessing on the multiple types of public information and the multiple types of private information based on time information and location information, and integrate the preprocessed information into a storage structure,
generate feature information including time-series information and spatial information with respect to the integrated information, generate teacher information indicating presence or absence or frequency of occurrence of a future event, and construct a prediction model by using a machine learning algorithm,
convert newly acquired public information and private information by using a processing operation identical to the feature-information generation, input the converted information into the prediction model, and calculate, for each area and for each time period, an event-occurrence probability or an event-risk index,
generate, on the basis of the calculated event-occurrence probability or the event-risk index, evaluation indicators and execution indicators related to resource allocation, patrol activity, monitoring-device placement, lighting-equipment placement, or other countermeasures, and
determine evaluation criteria including the evaluation indicators and the execution indicators, aggregate the evaluation criteria and the event-occurrence probability or the event-risk index, generate statistical values, graphical data, and structured data, and generate analysis-result data including the statistical values, the graphical data, and the structured data,
generate a prompt sentence including an input sentence that includes the analysis-result data and an instruction sentence that includes a creation policy for a policy explanation or a funding-application explanation based on the evaluation criteria,
input the prompt sentence into a generative information-processing model, acquire natural-language text from the generative information-processing model, and automatically generate, based on the natural-language text, a report material, an application material, or a supplementary material that conforms to a predetermined format,
generate countermeasure information, based on the evaluation criteria or the execution indicators, as notification information for a user terminal apparatus, and transmit the notification information to the user terminal apparatus, and
append, to the integrated information, countermeasure-implementation content and performance information acquired from the user terminal apparatus, and use the appended information for retraining or updating of the prediction model.

### (Supplementary 2)

The system according to supplementary 1,
wherein the processor is configured to
automatically extract, from the multiple types of public information and the multiple types of private information, information associated with a specific region unit or a specific organization unit, and, by generating the prediction model, the evaluation criteria, and the report material for each of the specific region unit or the specific organization unit using only the extracted information, enable region-specific analysis and countermeasure planning.

### (Supplementary 3)

The system according to supplementary 1,
wherein the processor is configured to
acquire format-definition information of the report material, the application material, or the supplementary material, and attribute information of a presentation target, specify, based on the format-definition information, a structure, a writing style condition, and an output length of the prompt sentence to be input into the generative information-processing model, include, in the prompt sentence, an instruction for adjustment of emphasis items, detail level, and expression difficulty based on the attribute information of the presentation target, and perform post-processing on an output result from the generative information-processing model so that the output result conforms to the format-definition information.

### Example 2

### (Supplementary 1)

A system comprising a processor, a data storage apparatus, a visualization apparatus, an information display apparatus, and a terminal apparatus,
wherein the processor is configured to acquire public organization information and private entity information from the data storage apparatus, and to generate an integrated data set by integrating a plurality of kinds of acquired data based on a common item schema,
wherein the processor is configured to perform numerical operations and aggregation processing on the integrated data set to calculate evaluation criterion information including evaluation indicators, and to format the evaluation criterion information as structured data for a document template,
wherein the processor is configured to extract visualization data from at least one of the integrated data set and the evaluation criterion information, and to generate tabular data and graph image data by performing data visualization,
wherein the processor is configured to read, from a storage device, a document template indicating a template for an application document or a report document, and to automatically assign, to items in the document template, numerical data, character data, and the visualization data based on a correspondence between the items and the structured data,
wherein the processor is configured to generate a prompt sentence as text information including at least a part of the integrated data set and the evaluation criterion information, to input the prompt sentence and the structured data into a generative AI model, and to thereby cause the generative AI model to automatically generate an explanatory text that constitutes a narrative portion of the application document or the report document,
wherein the processor is configured to synthesize the explanatory text and the visualization data into the document template to automatically generate an application document file or a report document file in a predetermined document format, to store the document file in an information storage apparatus, and to output distribution information of the document file, wherein the terminal apparatus is configured to receive the document file and the visualization data from the processor, to display the document and a visualization result on a display device, and to accept input of modification information and additional information from a user, and
wherein the processor is configured to update the structured data and the explanatory text based on the modification information and the additional information received from the terminal apparatus, and to regenerate at least a part of the application document or the report document based on updated content.

### (Supplementary 2)

The system according to supplementary 1,
wherein the processor is configured to identify, from the public organization information, a data group relating to a predetermined administrative region, to identify, from the private entity information, a data group relating to the predetermined administrative region, to combine the identified data groups to generate the evaluation criterion information and the visualization data in accordance with a regional characteristic, and to reflect an analysis result on a regional basis in the application document or the report document.

### (Supplementary 3)

The system according to supplementary 1,
wherein the processor is configured to select, from a plurality of document templates, a document template and a supplementary material template conforming to a predetermined format specification, to generate a prompt sentence including adjustment conditions relating to at least one of writing style, level of detail, emphasis item, and user intention, to input the prompt sentence into the generative AI model to adjust an expression content of the explanatory text, and to reflect the adjusted explanatory text in at least one of the application document, the report document, and a supplementary material.

### Application Example 2

### (Supplementary 1)

A system comprising a processor,
wherein the processor is configured to
acquire and integrate public information and non-public information,
calculate evaluation indicators based on integrated numerical information,
acquire time-series measurement information or transaction information and perform aggregation and visualization in association with the evaluation indicators,
operate a generative AI model using, as input, structured information including results of the aggregation and visualization and a prompt sentence comprising a natural-language instruction, and thereby automatically generate document data for reporting or application, create an electronic document including the document data and the visualization results in accordance with predetermined formatting information,
acquire emotion information or emotion estimation results related to a user, and modify at least one of the prompt sentence, the evaluation indicators, and the formatting information in accordance with the emotion information so as to dynamically adjust an output content or a target value of the generative AI model, and
convert the electronic document into an output format deliverable to a terminal device and output the electronic document.

### (Supplementary 2)

The system according to supplementary 1,
wherein the processor is configured to
use, as the time-series measurement information, operation state information acquired from detection devices installed in a production process, perform the aggregation and visualization to calculate productivity indicators, and input structured information including the productivity indicators into the generative AI model so as to automatically generate document data for reporting an operation status of the production process.

### (Supplementary 3)

The system according to supplementary 1,
wherein the processor is configured to
use, as the transaction information, expenditure information of a public organization or an individual, aggregate past-period spending tendencies to calculate analysis results including saving proposals, and input the analysis results and emotion information concerning anxiety or satisfaction of the user into the prompt sentence for the generative AI model so as to automatically generate document data for advice including an explanation of the spending tendencies and a concrete action plan.

What is claimed is:

1. A system comprising:
circuitry configured to:
receive, via a communication interface coupled to a packet-switched network, first structured data from a first data source and second structured data from a second data source, normalize formats and identifiers of the first structured data and the second structured data, and generate an integrated dataset by associating the normalized first structured data with the normalized second structured data;
set, in a storage device, an information structure comprising attribute types, constraint conditions, and association relationships, and store the integrated dataset in accordance with the information structure while maintaining referential consistency;
generate indicator data from the integrated dataset by computing quantitative metrics including change rates, ratios, and allocation amounts per unit quantity, and generate evaluation criteria based on the indicator data;
generate an analysis result comprising an information summary and a resource-distribution plan over a plurality of time periods based on the evaluation criteria and the indicator data, and store the analysis result as structured data in the storage device;
generate an input dataset comprising a prompt sentence, the evaluation criteria, and the analysis result, and supply the input dataset to a generative neural network model;
receive response data from the generative neural network model comprising draft document data for a plurality of document types over a plurality of time periods; and
generate tabular data and graphical data conforming to a predetermined output format based on the response data and the indicator data, and compose output document data incorporating the tabular data and the graphical data into the draft document data.

2. The system according to claim 1, wherein the circuitry is configured to acquire the first structured data from a publicly accessible data repository via the communication interface and the second structured data from a non-public data repository via the communication interface, and apply an identifier normalization algorithm to align entity identifiers across the first structured data and the second structured data prior to generating the integrated dataset.

3. The system according to claim 2, wherein the circuitry is configured to validate the integrated dataset by checking attribute types and constraint conditions defined in the information structure, detect constraint violations in the integrated dataset, and resolve the detected constraint violations by applying predefined reconciliation rules before storing the integrated dataset.

4. The system according to claim 3, wherein the circuitry is configured to compute, for each of a plurality of geographic regions, a region-specific indicator subset by filtering the integrated dataset by a geographic region identifier, generate region-specific evaluation criteria based on the region-specific indicator subset, and store the region-specific evaluation criteria as structured data associated with the geographic region identifier.

5. The system according to claim 4, wherein the circuitry is configured to generate a region-specific prompt sentence incorporating the region-specific evaluation criteria and the region-specific indicator subset, supply the region-specific prompt sentence to the generative neural network model, and obtain region-specific draft document data from the generative neural network model.

6. The system according to claim 1, wherein the circuitry is configured to generate the prompt sentence by selecting a prompt template based on a document type parameter, substituting the evaluation criteria and the analysis result into the prompt template, and appending constraint specifications that define required output format and document structure.

7. The system according to claim 6, wherein the circuitry is configured to receive an extended prompt sentence specifying additional analysis instructions from the terminal device, merge the extended prompt sentence with the generated prompt sentence, and supply the merged prompt sentence to the generative neural network model to generate extended draft document data.

8. The system according to claim 7, wherein the circuitry is configured to parse the draft document data received from the generative neural network model to identify structural markers designating positions for tabular data and graphical data, insert generated tabular data and graphical data at the identified positions, and output the composed document data as a formatted file conforming to a predetermined document schema.

9. The system according to claim 1, wherein the circuitry is configured to compute allocation amounts per unit quantity from the integrated dataset by applying a division operation to aggregated resource-quantity pairs, compute change rates by comparing indicator values across consecutive time periods, and store the computed allocation amounts and change rates as indicator records in the storage device.

10. The system according to claim 9, wherein the circuitry is configured to generate a multi-period projection by applying a trend-extrapolation algorithm to the stored indicator records, incorporate the multi-period projection into the analysis result as a resource-distribution plan, and supply the resource-distribution plan as part of the input dataset to the generative neural network model.

11. The system according to claim 1, wherein the circuitry is configured to receive updated first structured data or updated second structured data from the respective data source, detect a change between the updated data and previously stored data, regenerate the indicator data based on the updated integrated dataset, and regenerate the analysis result using the updated indicator data.

12. The system according to claim 11, wherein the circuitry is configured to generate a differential prompt sentence incorporating the detected change and the regenerated indicator data, supply the differential prompt sentence to the generative neural network model to generate updated draft document data, and update the stored output document data with the updated draft document data.

13. The system according to claim 1, wherein the circuitry is configured to receive a user-specified selection of a subset of the indicator data and a document type parameter from the terminal device, generate a targeted prompt sentence incorporating the selected indicator subset and the document type parameter, supply the targeted prompt sentence to the generative neural network model, and receive targeted draft document data from the generative neural network model.

14. The system according to claim 13, wherein the circuitry is configured to apply a format-conformance algorithm to the targeted draft document data to verify compliance with a predetermined output schema, detect format deviations, and regenerate portions of the targeted draft document data that exhibit format deviations by supplying a correction prompt sentence to the generative neural network model.

15. The system according to claim 1, wherein the circuitry is configured to store a history of generated analysis results, evaluation criteria, and response data in the storage device, and supply at least a portion of the stored history as context data in subsequent prompt sentences to the generative neural network model to improve consistency of document generation across time periods.

16. The system according to claim 1, wherein the circuitry is configured to generate graphical data by applying a visualization algorithm to the indicator data to produce chart data representing trends and distributions, convert the chart data into a predetermined image format, and embed the converted chart data into the composed output document data at positions specified by structural markers in the draft document data.

17. The system according to claim 1, wherein the circuitry is configured to generate a supplementary dataset comprising annotation data and reference data associated with the output document data, store the supplementary dataset in the storage device in association with the output document data, and transmit the output document data and the supplementary dataset to the terminal device as a combined output package.

18. A system comprising:
circuitry configured to:
receive, via a communication interface coupled to a packet-switched network, first structured data and second structured data from respective data sources, normalize identifiers and formats, and generate an integrated dataset stored in accordance with an information structure comprising attribute types and constraint conditions;
compute quantitative indicator data from the integrated dataset including change rates, ratios, and allocation amounts per unit quantity, and generate evaluation criteria based on the indicator data;
generate a prompt sentence incorporating the evaluation criteria and an analysis result derived from the indicator data, supply the prompt sentence to a generative neural network model, and receive draft document data from the generative neural network model; and
generate tabular data and graphical data from the indicator data and compose output document data by incorporating the tabular data and the graphical data into the draft document data according to a predetermined output format.

19. The system according to claim 18, wherein the circuitry is configured to receive a region-specific data filter parameter from a terminal device, apply the region-specific data filter parameter to the integrated dataset to derive a region-specific indicator subset, generate a region-specific prompt sentence incorporating the region-specific indicator subset, and supply the region-specific prompt sentence to the generative neural network model to obtain region-specific draft document data.

20. A method performed by circuitry, the method comprising:
receiving, via a communication interface coupled to a packet-switched network, first structured data from a first data source and second structured data from a second data source, normalizing formats and identifiers of the first structured data and the second structured data, and generating an integrated dataset by associating the normalized first structured data with the normalized second structured data;
setting, in a storage device, an information structure comprising attribute types, constraint conditions, and association relationships, and storing the integrated dataset in accordance with the information structure while maintaining referential consistency;
generating indicator data from the integrated dataset by computing quantitative metrics including change rates, ratios, and allocation amounts per unit quantity, and generating evaluation criteria based on the indicator data;
generating an analysis result comprising an information summary and a resource-distribution plan over a plurality of time periods based on the evaluation criteria and the indicator data, and storing the analysis result as structured data in the storage device;
generating an input dataset comprising a prompt sentence, the evaluation criteria, and the analysis result, and supplying the input dataset to a generative neural network model;
receiving response data from the generative neural network model comprising draft document data for a plurality of document types over a plurality of time periods; and
generating tabular data and graphical data conforming to a predetermined output format based on the response data and the indicator data, and composing output document data incorporating the tabular data and the graphical data into the draft document data.
